(19) United States
(12) Patent Application Publication
(10) Pub. No.: US 2024/0273647 A1
(43) Pub. Date: Aug. 15, 2024

(54) INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventors: KOJI MAKARA, Tokyo (JP); HIROYUKI NAKAYA, Kanagawa (JP)

(21) Appl. No.: 18/427,978

(22) Filed: Jan. 31, 2024

(30) Foreign Application Priority Data
Feb. 10, 2023 (JP) 2023-018995
Jan. 10, 2024 (JP) 2024-001678

(51) Int. Cl. G06Q 50/06; G06F 18/243

(52) U.S. Cl. CPC G06Q 50/06; G06F 18/243

(57) ABSTRACT

An information processing apparatus includes a classification information obtaining portion, a data obtaining portion, and a classification processing portion. The classification information obtaining portion is configured to obtain classification group information including a plurality of classification groups in each of which a classification item is configured, and association information associating the classification items of the plurality of classification groups with each other. The data obtaining portion is configured to obtain data of power consumed in a facility. The classification processing portion is configured to classify the data obtained by the data obtaining portion, by using the classification group information and the association information obtained by the classification information obtaining portion.

### BACKGROUND OF THE INVENTION

### Field of the Invention

The present invention relates to an information processing apparatus, an information processing method, and the like.

### Description of the Related Art

Conventionally, attempts to analyze the usage status of energy to reduce waste are made in various fields.

Japanese Patent Laid-Open No. 2013-222256 proposes an apparatus that generates, by using energy information of production equipment and production status information, a graph in which production status information of each apparatus and energy usage amount are associated.

### SUMMARY OF THE INVENTION

According to a first aspect of the present invention, an information processing apparatus includes a classification information obtaining portion, a data obtaining portion, and a classification processing portion. The classification information obtaining portion is configured to obtain classification group information including a plurality of classification groups in each of which a classification item is configured, and association information associating the classification items of the plurality of classification groups with each other. The data obtaining portion is configured to obtain data of power consumed in a facility. The classification processing portion is configured to classify the data obtained by the data obtaining portion, by using the classification group information and the association information obtained by the classification information obtaining portion.

According to a second aspect of the present invention, an information processing method includes obtaining, by a classification information obtaining portion, classification group information including a plurality of classification groups in each of which a classification item is configured, and association information associating the classification items of the plurality of classification groups with each other, obtaining, by a data obtaining portion, data of power consumed in a facility, and classifying, by a classification processing portion, the data obtained by the data obtaining portion, by using the classification group information and the association information obtained by the classification information obtaining portion.

Further features of the present invention will become apparent from the following description of exemplary embodiments with reference to the attached drawings.

### BRIEF DESCRIPTION OF THE DRAWINGS

FIG. 1 is a schematic block diagram illustrating an example of a configuration of an information processing apparatus according to an embodiment.

FIG. 2 is a schematic diagram illustrating that a plurality of databases is systematically associated in a hierarchical structure.

FIG. 3 is a schematic diagram illustrating an example of a classification system used for classifying uses of consumed energy.

FIG. 4 is a schematic diagram illustrating an example of a classification system used for classifying added values.

FIG. 5 is a schematic diagram illustrating an example of items for classifying an operable time period into time periods in a hierarchical manner.

FIG. 6 is a schematic diagram illustrating an example of classification items used for classification based on the content of energy consumption.

FIG. 7 is a flowchart for describing a processing flow for displaying a result of classification by a classification processing portion.

FIG. 8 is a diagram illustrating an example of a graph of energy consumption amounts classified for each workplace and use.

FIG. 9 is a diagram illustrating an example of transition of the total energy consumption amount of a target facility.

FIG. 10A is a diagram illustrating an example of a graph of classification results regarding the equipment and operation content.

FIG. 10B is a diagram illustrating an example of a graph in which the level of waste is classified for each time period.

FIG. 11 is a diagram illustrating a result of comparison between a plurality of pieces of equipment in terms of the amount and proportion of the net, the incident, and the waste.

FIG. 12 is a diagram illustrating an example of a graph of classification results for each unit and consumption content.

FIG. 13 is a schematic diagram illustrating an operation of a cutting processing apparatus cutting off a target material in a cutting process in a stepped configuration.

FIG. 14 is a schematic diagram illustrating an operation of a cutting apparatus cutting off a target material by a different method in a cutting process stepwise.

FIG. 15 is a schematic block diagram illustrating an example of a configuration of an information processing apparatus according to an embodiment.

FIG. 16 is a diagram illustrating an example of a result of comparing actual values of an energy intensity in an operation time with a standard value and determining whether the energy usage status is normal or abnormal.

FIG. 17 is a diagram illustrating an example of a result of comparing actual values of equipment in a non-operation time with a standard value and determining whether the energy usage status is normal or abnormal.

FIG. 18 is a schematic block diagram illustrating an example of a configuration of an information processing apparatus according to an embodiment.

FIG. 19 is a diagram illustrating an example of a result of displaying, on a display portion, an introduction status of renewable energy in a target facility.

FIG. 20 is a diagram illustrating an example of results of simulation of a predicted cost for each procurement means on the basis of the electric energy that the target facility needs.

### DESCRIPTION OF THE EMBODIMENTS

Japanese Patent Laid-Open No. 2013-222256 discloses that, for a production apparatus, the power consumption amount for the production of products, the power consumption amount during idling, the power consumption amount during a short-time breakdown, the power consumption amount during a preceding step, and the power consumption amount during a succeeding step are shown in a graph.

In this method, although it is easy to grasp how much of power consumption occurs in what timing of what state of the production apparatus, it is difficult to grasp where and how much of necessary power consumption and other power consumption among the power consumption amount occur. Therefore, it is difficult for the administrator and operator of equipment to distinguish, from each other, necessary power consumption and other power consumption that occur for each place and use, and it is difficult to examine a practical improvement measure (for example, improving or replacing the apparatus) for suppressing power consumption.

Therefore, a technique for a user to easily grasp the use, added value, and the like of power consumption occurring in each element for a facility including a plurality of elements that consume power has been desired. Examples of the facility include apparatuses, equipment, and systems.

An information processing apparatus, an information processing method, and the like serving as an embodiment of the present invention will be described with reference to the drawings. The embodiments shown below are merely examples, and for example, details of the configuration thereof can be appropriately modified for implementation within the scope of the gist of the present invention.

To be noted, in the drawings referred to in the description of the embodiments below, it is assumed that elements denoted by the same reference signs have substantially the same functions unless otherwise described. In the drawings, in the case where a plurality of the same elements is arranged, assignment of the reference signs and description thereof may be omitted.

In addition, since there is a case where drawings are schematically expressed for the sake of convenience of illustration and description, the shapes, sizes, and arrangement of the elements illustrated in the drawings may not strictly match those in the real life.

### First Embodiment

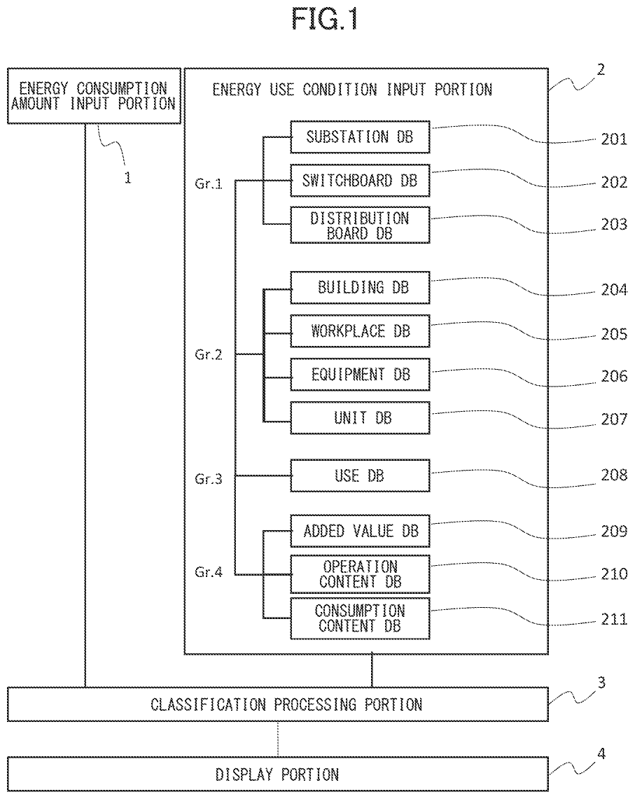

FIG. 1 is a schematic block diagram illustrating an example of an information processing apparatus according to a first embodiment. Functional elements required for describing the characteristics of the present embodiment are illustrated as functional blocks in FIG. 1, and description of general functional elements that are not directly related to the problem-solving principle of the present invention is omitted. In addition, each functional element illustrated in FIG. 1 is functionally conceptual, and does not have to be physically configured as illustrated. For example, the specific form of separation and integration of each functional block is not limited to the illustrated example, and the entirety or part thereof can be functionally or physically separated or integrated in arbitrary units in accordance with the usage status or the like.

Each functional block can be constituted by software executed by a computer or hardware. That is, each functional block can be constituted by, for example, a central processing unit: CPU reading and executing a control program. Alternatively, the functional blocks can be partially or entirely constituted by hardware such as an application-specific integrated circuit: ASIC included in an information processing apparatus. In addition, the functional blocks may be partially or entirely constituted by providing the one CPU described above, or the functional blocks may be partially or entirely constituted by providing a plurality of CPUs and operating the CPUs in a cooperative manner. In addition, the functional blocks may be partially or entirely constituted by a CPU including a plurality of cores.

The information processing apparatus of the present embodiment can include a CPU, an input/output port: I/O port, and a computer-readable recording medium. As the computer-readable recording medium, a non-transitory recording medium that stores a processing program to be executed by the CPU, parameters required for execution of the processing, and the like can be used. As the non-transitory recording medium, for example, flexible disks, optical disks, magneto-photo disks, magnetic tapes, universal serial bus memories: USB memories, solid state drives: SSDs, and the like can be used. In addition, the information processing apparatus can include a rewritable recording medium (random access memory: RAM or the like) that provides a storage area required for processing such as calculation.

The information processing apparatus of the present embodiment can include a display apparatus and/or an input apparatus. In addition, the information processing apparatus may be configured to be connectable to an external display apparatus and/or an external input apparatus. The display apparatus and/or the input apparatus can be used as a user interface. As the display apparatus, for example, display devices such as a liquid crystal display or an organic electroluminescence display is used, and as the input apparatus, for example, an input device such as a keyboard, a jog dial, a mouse, a pointing device, a sound input device, or the like is used.

The information processing apparatus of the present embodiment can display an operation assistance screen on the display apparatus when a user performs an operation such as generating, editing, or checking various databases that will be described later. In addition, the information processing apparatus of the present embodiment can receive and obtain information (for example, instructions and data related to generation and editing of the databases) input via the input apparatus.

FIG. 1 illustrates an example of the configuration of the information processing apparatus according to the present embodiment, and the information processing apparatus includes an energy consumption amount input portion 1, an energy use condition input portion 2, a classification processing portion 3, and a display portion 4. In FIG. 1, Gr. 1 to Gr. 4 are each a classification group in which classification items are hierarchically configured, and Gr. 1 to Gr. 4 can be collectively referred to as classification group information. The energy consumption amount input portion 1 is an input portion that obtains data of power consumption of power consumed in the facility. The energy consumption amount input portion 1 can be also referred to as a data obtaining portion. The energy use condition input portion 2 is a classification information obtaining portion that obtains classification group information including a plurality of classification groups in which classification items are hierarchically configured, and association information associating the classification items of the plurality of groups with each other. The classification processing portion 3 is a classification processing portion that classifies the data of the power consumption obtained by the input portion, by using the classification group information and the association information obtained by the classification information obtaining portion. Each block illustrated in FIG. 1 will be described below.

The energy use condition input portion 2 includes a database in which use conditions of energy in a facility such as a production factory that consumes power into a plurality of items and are accumulated in an organized manner such that search can be performed in accordance with the purpose. The database may be also referred to as a DB below. To be noted, the term “facility” can refer to the entirety including apparatuses, equipment, systems, and production lines, or can refer to an individual element constituting the entirety.

A substation DB 201 is a database in which information of substations hierarchically installed in a facility or equipment serving as a target of information processing is recorded. Names of an extra-high voltage substation that transforms an extra-high voltage power (for example, 66 kV) into a high-voltage power (for example, 6 kV) to be used in the facility and supplies the high-voltage power and a sub-substation that is installed in an electrical room in the facility and transforms a high-voltage power into a low-voltage power (for example, 400 V, 200 V, 100 V, or the like) are recorded.

To be noted, each substation normally transforms the voltage and has a measuring instrument that measures the electric energy serving as the energy consumption amount. Therefore, by inputting the measurement data from the measuring instrument to the energy consumption amount input portion 1, the classification processing portion 3 can classify the electric energy in association with the name of the extra-high voltage substation and the name of the sub-substation in the substation DB 201. As a result of this, how much of energy has been consumed in which substation in how long a period can be grasped, and the processing results of the classification can be displayed on the display portion 4. In addition, the unit of the measurement data input to the energy consumption amount input portion 1 may be electric power (W) or may be electric energy (kWh) or (Wh).

A switchboard DB 202 of the energy use condition input portion 2 is a database in which information (for example, names) of switchboards that have a function of receiving power transformed by a transformer of the sub-substations, distributing the power to each area in the facility, and supplying power is recorded.

A distribution board DB 203 is a database in which information (for example, names) of distribution boards having a function of distributing the power to loads of the electric system further downstream of the switchboards, that is, to equipment used in each workplace in the facility is recorded. Since a distribution board is disposed downstream of an electric system (energy flow) branching from the switchboard, the distribution board is provided in a greater number than the switchboard, and many distribution boards are disposed in each area in the facility.

A building DB 204 is a database in which information (for example, names) of buildings constituting the facility that consumes power is recorded. In a large facility such as a production factory or a development site, since a plurality of buildings are provided, a building is a constituent element of the facility. By classifying the energy consumption amount by associating the building DB 204, the substation DB 201, and the switchboard DB 202 with each other, the energy consumption amount can be grasped for each building.

To be noted, the range of constituent units of substations and buildings vary depending on the facility, and for example, there is a case where power is supplied from one substation to a plurality of buildings, a case where substations and buildings are provided in a one-on-one relationship, and a case where power is supplied from a plurality of substations to one building. This is because the buildings are designed and built in various manners in accordance with the scale of energy consumption amount of the facility. In addition, there is a case where a substation needs to be additionally built for a reason regarding the facility operation such as introduction of a plurality of pieces of equipment that consumes a lot of power after the facility is built, and the relationship between the substation DB 201 and the building DB 204 needs to be updated. Therefore, by accumulating the information about substations serving as suppliers and measurement points of the energy and the buildings serving as demanders in a database in an organized manner, the energy consumption amount can be easily managed.

In addition, similarly, the switchboards and distribution boards can be newly installed in the case where, for example, equipment that consumes power is newly installed after building the facility and the number of branches becomes insufficient. Alternatively, there is a case where something that was present when the facility was built is broken down later or that something is reinstalled. Therefore, by recording the names of the switchboards and distribution boards in the switchboard DB 202 and the distribution board DB 203 and regularly updating the switchboard DB 202 and the distribution board DB 203, the energy consumption amount can be easily managed.

A workplace DB 205 is a database in which information (for example, names) of workplaces serving as units of operation of the facility that consumes power is recorded. In the description of the present embodiment, the unit for management of the energy consumption amount will be defined as a workplace for the sake of convenience. The workplace is a form of a division of a place where people work, and is a concept of a narrower range than a physical division such as a facility or a building. Generally, a workplace is constituted by workforce, fixed assets such as equipment held by an organization, and items required for executing the work such as consumable tools and equipped goods. The work in the facility is executed in each workplace organized in accordance with the purpose, and is executed by using various equipment installed in the facility. In addition, since the purpose of the work changes over time, the configuration of the workplace also changes in accordance with the purpose.

In addition, the workplace DB 205 may record the content of the work in addition to the names of the workplaces, and for example, in the case of a workplace in charge of production, step information indicating which step among steps for producing a product the workplace is in charge of may be recorded. Alternatively, if the workplaces are classified in accordance with the models of products and are configured as a factory that produces a plurality of products as a whole, information about the model of the product may be added. Alternatively, in the case of workplaces that produce parts common to a plurality of models, the operation efficiency of the facility is higher if the workplaces are organized in accordance with the types of the parts, information about the types of the parts may be added. Alternatively, in the case of a workplace in charge of an indirect work that does not directly involve production but is necessary for management of the facility, information about the content of the work in the workplace such as a development work for a next product, a planning work, a personnel work, and a general affairs work may be added. By adding such information about the workplace, the characteristics of the workplace can be understood, and in the range contributing to the classification of the workplaces serving as units of operation of the facility, the content of the database recorded in the workplace DB 205 should not be restricted by any means.

Each workplace recorded in the workplace DB 205 is responsible for managing the energy consumption amount and is responsible for an energy consumption reduction activity. As will be described later, by associating the energy consumption amount of a certain time period input to the energy consumption amount input portion 1 with the workplace DB 205, the energy consumption amount in each workplace can be grasped.

As described above, the workplace whose concept is defined in the present embodiment has a characteristic that the configuration thereof changes in accordance with the purpose of the operation, and a characteristic that the workplace is a demander of the energy in the facility and is responsible for management of the energy consumption amount and for the energy consumption reduction activity. In the information processing apparatus of the present embodiment, by recording the names and the like of the workplaces in the workplace DB 205 and updating the database in accordance with the change, the energy consumption amount in each workplace can be easily managed.

An equipment DB 206 is a database in which information about various equipment constituting the facility, such as equipment that is installed in each workplace of the facility and has a function of production or development required for the operation, and infrastructure equipment. Examples of the infrastructure equipment include electronic devices such as personal computers: PCs, displays, and printers, equipment for conditioning the work environment of the facility such as air conditioners and lights, and shared equipment that is commonly necessary such as elevators, surveillance cameras, drains of restrooms, and smoke exhaustion for disasters.

The equipment DB 206 may record information such as names of all the pieces of equipment constituting the facility, or may record names of only the main pieces of equipment that consume a lot of power. When counting and analyzing the energy consumption of the facility that consumes power by using the information processing apparatus of the present embodiment, whether only the main pieces of equipment are selected as the target equipment to be recorded in the database or also smaller pieces of equipment are selected as the target equipment to be recorded in the database may be determined in accordance with the aimed analysis precision.

In addition, the equipment DB 206 may record not only the names of the equipment but also information about the magnitude of consumption of power such as the rated voltage, rated current, and rated power of the equipment, information about the phase of power supply such as three-phase or single-phase, or information about the function of the equipment. Alternatively, step information indicating which step the equipment is in charge of in the production may be recorded. A database in which the name of equipment is associated with the name of a step may be configured and used as classification items for managing the energy consumption amount. For example, an injection molding machine A is recorded as a piece of equipment in charge of a molding step of a molded part used for a specific product.

A unit DB 207 is a database in which elements constituting the equipment described in the equipment DB 206 is recorded. For example, an injection molding machine can be registered as equipment in charge of an injection molding step, and the injection molding machine includes constituent elements (units) such as an injection motor, a cylinder heater, a weight measuring motor, a clamping motor, and an ejection motor. A mold temperature adjuster that is accessory equipment of the injection molding machine includes, for example, units such as a pump for circulating cooling water, and a heater. In addition, a plastic material dryer that is other accessory equipment of the injection molding machine includes, for example, units such as a blower and a heater. As described above, the equipment for operating the facility that consumes power functions as equipment by including units having specific functions as constituent elements and operating the units in combination, and the equipment itself operates as one system. The unit DB 207 records information (for example, names) of such units.

In addition, similarly to the additional information of the equipment described above, in the unit DB 207, not only the names of the units but also information about the magnitude of consumption of power such as the rated voltage, rated current, and rated power of the equipment, information about the phase of power supply such as three-phase or single-phase, or information about the function of the equipment may be recorded. Alternatively, information about the function that the equipment has (for example, description like “the injection motor is a unit that injects a plastic material melted by a cylinder heater into a mold”) may be recorded. The unit has a wide variety of configurations in accordance with the type of the equipment. For example, a large piece of equipment includes a large number of units as constituent elements, and a small piece of equipment includes a small number of units. The unit described in the unit DB 207 can be set as the minimum unit among the constituent elements that consume energy in the facility that consumes power.

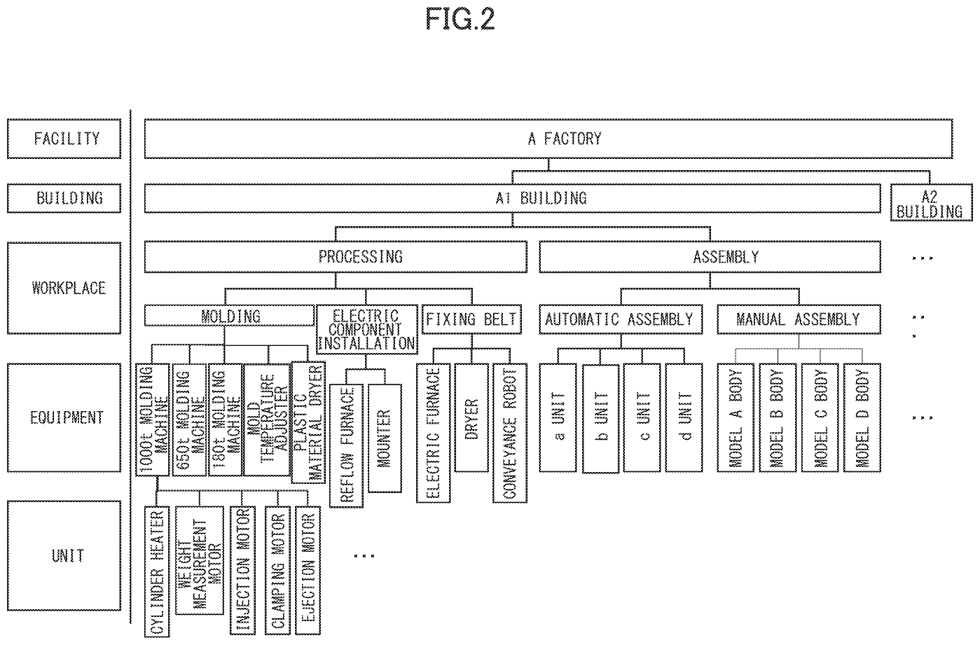

FIG. 2 is a schematic diagram illustrating that the building DB 204, the workplace DB 205, the equipment DB 206, and the unit DB 207 are systematically associated in a hierarchical structure in the embodiment. In FIG. 2, the facility that consumes power is classified in accordance with classification items divided stepwise, for example, workplaces, equipment, and units from the building in the higher hierarchy to the lower hierarchy, and thus the database of the facility is configured as a whole. For example, the facility that consumes power is constituted by a plurality of buildings. One building among these is constituted by a plurality of workplaces. One workplace among these is constituted by a plurality of pieces of equipment. One piece of equipment among these is constituted by a plurality of units of a wide variety in accordance with the type of the facility.

In view of this configuration, the databases of the building DB 204, the workplace DB 205, the equipment DB 206, and the unit DB 207 can be referred to as relational databases that are related to each other. In the present embodiment, the mutual relationship between the classification items is systematically configured in advance and thus managed. By defining the relationship in advance as described above, the energy usage amount of the energy consumed by the group of constituent elements can be systematically managed (for example, accumulated, analyzed, and visualized) while maintaining the relationship between the consumption elements.

Incidentally, power receiving equipment and power supplying equipment described in the substation DB 201, the switchboard DB 202, and the distribution board DB 203 are installed at the time of building the facility in accordance with the branching system of power for the purpose of supplying power in the facility. Therefore, the power receiving/supplying equipment is installed not necessarily in relation to the types of equipment and units serving as a load that consumes power. The power receiving/supplying equipment is installed such that for example, power transmission loss (energy loss) at the time of supply is small and the investment-effectiveness of the building cost is high.

Therefore, the substation DB 201, the switchboard DB 202, and the distribution board DB 203 are associated as one classification group (Gr. 1) as illustrated in FIG. 1. In contrast, the building DB 204, the workplace DB 205, the equipment DB 206, and the unit DB 207 are configured for a different purpose than (Gr. 1), and thus are associated as one classification group (Gr. 2).

For example, if the facility is a production factory, since the workplaces are configured such that the efficiency of the operation mode that a plurality of kinds of products are mass-produced in the factory is the highest, there is a case where a plurality of workplaces are provided in a certain range in a building, and there is also a case where a common workplace is provided throughout a plurality of buildings. Although many pieces of equipment are installed in the workplaces, the relationship between the workplaces and equipment is not necessarily related to the energy flow, and there is a case where the energy flow branches from a certain distribution board to a plurality of workplaces, a case where the distribution boards and the workplaces are in a one-on-one relationship, and a case where a plurality of distribution boards are provided in a certain workplace.

Therefore, regarding the relationship between the classification group Gr. 1 and the classification group Gr. 2, a calculation formula for distributing the energy consumption amount of one distribution board, calculating the sum of the energy consumption amounts of a plurality of distribution boards, or the like is defined in advance in the energy use condition input portion 2. For example, a case where the data input to the energy consumption amount input portion 1 is data for each distribution board recorded in the distribution board DB 203 and the range to which the distribution board supplies power includes a plurality of workplaces will be considered. To count the energy consumption amount for each workplace, a distribution calculation to determine what is the proportion of part of the measured energy attributed to a molding workplace in FIG. 2 and what is the proportion of another part of the measured energy attributed to an electric component installation workplace is required.

For example, a case where a compressed air generated by a compressor is supplied to the molding workplace and the electric component installation workplace through piping will be described as an example. The energy use condition input portion 2 can calculate the distribution ratio by estimating the air consumption amount from the specifications of the air flow amount of the equipment in advance. Alternatively, the distribution ratio can be calculated on the basis of the actual values of consumption amount obtained by actual measurement in a certain time period such as one week or one month, and can be recorded in association with the name of the workplace in the workplace DB 205.

In contrast, in a 1000-t molding machine of the molding workplace of FIG. 2, in the case where power supplied from a distribution board unique to the molding workplace is used, 100% of the energy consumption amount measured at the distribution board is counted as being attributed to the molding workplace.

In addition, since a turbo freezer for generating a cold water for cooling air taken in from the outside of the building by air handling unit equipment is in charge of cooling the air of all the workplaces in the facility, the area of each workplace is calculated in advance, and the area ratio is recorded in the workplace DB 205 as the distribution ratio of air conditioning. Similarly, the energy load of the illumination equipment can be treated as proportional to the area of the workplace. Therefore, by recording the area ratio, the distribution of the energy consumption amount measured at the distribution board can be calculated for each workplace on the basis of an appropriate basis even in the case where the range illuminated by the illumination equipment include a plurality of workplaces.

For example, in the case of supplying a cold water that is concentratively generated in a cooling tower, circulates between a plurality of apparatuses, and cools the plurality of apparatuses, or supplying a power for robots to a plurality of assembly workplaces from a factline connected to one distribution board, the distribution ratio may be determined on the basis of the rated power of the apparatuses serving as loads. Alternatively, the distribution ratio may be determined with a higher precision on the basis of actual measured values of a certain time period.

Similarly, the distribution ratio of each workplace can be determined for equipment of other uses. According to the present embodiment, to which workplaces the energy consumption amounts measured at measurement points such as the distribution boards are attributed is comprehensively investigated in advance, the distribution ratio is calculated on the basis of predetermined rules such as the specifications of the equipment and the measured values, and a database can be thus configured in the workplace DB 205. For example, in the case where a range to which energy is supplied from a measurement point is equal to or narrower than a single workplace, 100% of the measured electric energy is attributed to the workplace. In the case where the range to which energy is supplied is wider than a single workplace, the energy can be distributed to each workplace by a predetermined distribution ratio, and can be counted and classified.

Alternatively, the energy consumption amount may be distributed to workplaces after being added up for each use. For example, the energy consumption amounts of equipment for air conditioning such as the turbo freezer and the air handling unit may be added up, and then the total value may be distributed to all the workplaces on the basis of the area ratio. According to this configuration, the distribution results can be obtained without comprehensively grasping the relationships between the workplaces and the distribution boards to which individual air handling units that are provided in the facility in a large number. Similarly, the energy consumption amounts of the distribution boards used for illumination may be added up and then distributed to the workplaces in accordance with the area.

To be noted, the electric energy of the production equipment such as a molding machine and an assembly robot can be added up and then distributed to each workplace on the basis of the rated power of the equipment. However, in this case, there is a possibility that the distribution value is concentrated on a workplace whose rated power of the equipment is large. Therefore, the distribution is calculated from the sum in the case where the purpose is to easily calculate the distribution value, and in the case where the purpose is to realize a high precision, it is preferable that the relationship between the distribution board and workplace to which each piece of equipment is connected is comprehensively investigated, and the distribution is performed in the range of workplace that the equipment is in charge of.

Therefore, a rule that the energy of a distribution board connected to infrastructure equipment of a building such as air conditioners and lights is distributed to all the workplaces from the sum of each use. In contrast, the rules for distribution calculation may be switched such that the energy of a distribution board connected to equipment for the use of production of a product or a part such as a molding machine or an assembly robot is distributed to a workplace within the range that the individual distribution board is in charge of.

By defining the relationship between the classification items in advance, the energy consumption amount in each element can be appropriately grasped for apparatuses, equipment, and systems including a plurality of elements that consume power, regardless of whether or not the physical branch system for power supply is the same. The classification processing portion 3 executes the classification processing for the energy consumption amount input to the energy consumption amount input portion 1 in accordance with the classification items of the relational database recorded in the energy use condition input portion 2. As a result of this, the energy consumption amount can be obtained and analyzed without loss or redundancy.

To be noted, in the first embodiment, the point in the power system where the energy is measured does not have to be a distribution board, and may be, for example, a switchboard. Although all the distribution boards in the facility that consumes power can supply power, it is not always the case that the data of the energy consumption amount can be measured at all the distribution boards. In the description below, the unit of distribution board will be referred to as a board, and a case where there is a restriction in data acquisition that, for example, the data can be obtained in both the switchboards and the distribution boards for 80 boards among 100 distribution boards, and for the remaining 20 boards, the data can be obtained at the switchboards upstream thereof but cannot be obtained at the distribution boards will be considered.

In such a case, the energy consumption amount obtained in either a switchboard or a distribution board is distributed to each workplace as in the example described above. Since the switchboards are upstream of the distribution boards in the power system, it is more preferable to distribute the power to each workplace from the distribution board, which is positioned more downstream, from the viewpoint of improving the precision of the distribution results. Therefore, it is preferable that the energy consumption amount is distributed from the distribution board in the case where the energy consumption amount can be measured in the hierarchy of the distribution board, and in the case where the energy consumption amount can be measured only at the switchboard, which is in a higher hierarchy, the energy consumption amount measured at the switchboard is distributed to each workplace not via a distribution board.

At this time, in the case where processing that for the 80 boards, the energy consumption amount is distributed from the distribution boards to the workplaces, and for the remaining 20 boards, the energy consumption amount is distributed from the switchboards to the workplaces is performed by the classification processing portion 3, since the used measurement points differ depending on at which hierarchy in the power system the data can be obtained, the calculation processing can be complicated. Therefore, for the 20 boards where the measurement can be performed only at the switchboards, it is preferable that the energy consumption amount measured at the switchboards is distributed to the hierarchy of distribution boards in advance by associating the switchboard DB 202 with the distribution board DB 203 by the classification processing portion 3. According to this configuration, the classification processing portion 3 can uniformize the hierarchy of the data of the energy consumption amount that is not uniform at the time of measurement to the hierarchy of the distribution boards in the power system. As a result of this processing, all the data of energy consumption amount can be collectively distributed to each workplace from the hierarchy of distribution boards.

A use DB 208 is a database in which uses of energy consumed in the facility that consumes power are recorded. The use DB 208 constitutes a group Gr. 3 different from Gr. 1 and Gr. 2 described above. The uses of energy are roughly divided into two, which are an infrastructural use that is a use of energy for conditioning the residential environment, and a productive use that is a use of energy for operating production equipment. The infrastructural use is further divided into, for example, an illumination use, an air conditioning use, and other infrastructural use, and the productive use is further divided into a thermal use, a driving use, an air use, a vacuum use, and other productive use.

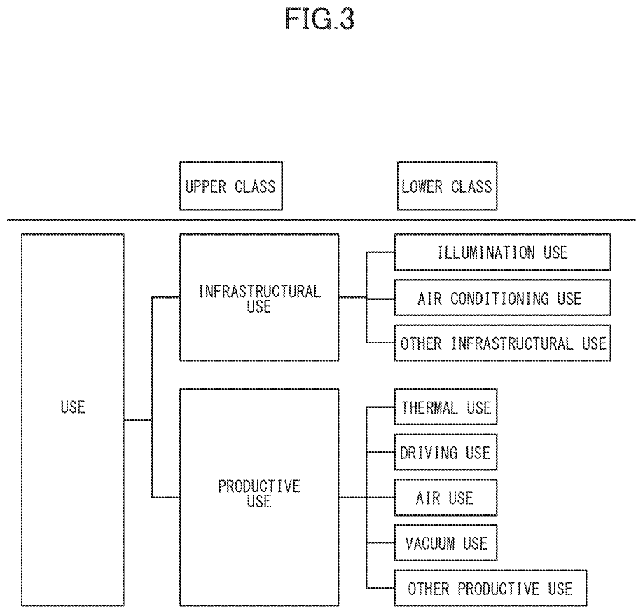

FIG. 3 is a schematic diagram illustrating an example of a classification system used for classifying the uses related to consumed energy in the embodiment. In FIG. 3, the uses of energy are classified into the infrastructural use and the productive use in an upper hierarchy of classification. It is illustrated that the infrastructural use is further divided into the illumination use, the air conditioning use, and the other infrastructural use in the lower hierarchy, and the productive use is further divided into the thermal use, the driving use, the air use, the vacuum use, and the other productive use. By configuring the database by forming a system of uses of energy by using such a hierarchical structure, the energy of the facility that consumes power can be classified without loss or redundancy.

The classification of the buildings, workplaces, equipment, and units in Gr. 2, the classification items are configured vertically in accordance with the function in the system for operating the facility. In contrast, for the uses of energy in Gr. 3, the classification items are laterally configured as a shared classification concept common to the buildings, workplaces, equipment, and units. For example, the thermal use of energy is commonly applied to a cylinder heater of an injection molding machine of a molding workplace, a reflow furnace of an electric component installation workplace, and an electric furnace of a different workplace, and thus the energy consumption is classified.

On the basis of the classification method for the uses of energy in the present embodiment, it can be understood that, in the classification hierarchy of the workplaces in the workplace DB 205, for example, all of a molding workplace, an electric component installation workplace, and a fixing belt workplace consume energy for the thermal use. In addition, in the classification hierarchy of equipment in the equipment DB 206, the consumed energy can be classified from the viewpoint of use of energy. For example, the consumed energy can be classified from the viewpoint of uses of energy indicating that a 1000-t molding machine, a 650-t molding machine, and a 180-t molding machine all consume energy for the thermal use, and a reflow furnace attributed to the electric component installation workplace, which is a different workplace, also consumes energy for the thermal use.

Meanwhile, the 1000-t molding machine of the molding workplace can be classified as having uses of energy classified into the driving use such as a measurement motor, an injection motor, a clamping motor, and an ejection motor. In addition, a mounter of the electric component installation workplace can be classified into the driving use of energy, and a conveyance robot in a different workplace can be classified into the driving use of energy. Further, automatic assembly equipment that automatically assembles a unit of a product is provided in an automatic assembly workplace, and equipment provided for assembling these product units can be classified into the driving use in the concept of use of energy.

In view of such a classification system of energy, the energy consumption amount can be classified such that in the energy consumed in a certain hierarchy of workplace, a certain ratio of consumption amount is classified into the thermal use, and another ratio of consumption amount is classified into the driving use. In addition, in the energy consumed in the hierarchy of equipment, a certain ratio of consumption amount can be classified into the thermal use, and another ratio of consumption amount can be classified into the driving use.

In the hierarchy of buildings, there is a case where, for example, uses of energy corresponding to all classifications are present in an A1 building of the factory, but in an A2 building, which is a power building that performs energy conversion, does not consume energy for, for example, the thermal use. Specifically, for example, there is a case where, in the A2 building, energy of specific uses such as the turbo freezer of the air conditioning use, the illumination use for using the A2 building, and a compressor of the air use for the purpose of supplying the compressed air to the entirety of the facility is concentratively consumed.

In the present embodiment, the use DB 208 has items for uses of energy that are commonly (laterally) applicable to one of more hierarchies among hierarchies (buildings, workplaces, equipment, units constituting the equipment, and the like) of the facility in the operation system of the facility. That is, the use DB 208 can have a database structure in which the contents of energy consumption used in each hierarchy of the facility are divided in accordance with the uses of energy such as the thermal use, the driving use, the air use, and the vacuum use. Therefore, in any hierarchy of the operation system of the facility, the energy consumption amount can be commonly (laterally) classified on the basis of the uses of energy.

To be noted, in the example illustrated in FIG. 3, although the uses of an upper hierarchy are classified into the infrastructural use and the productive use, these names do not have to be always used, and different names of uses may be used in the range of describing the concept thereof. For example, in a development site where the operation purpose of the facility is product development, the uses may be classified into the infrastructural use and a development use. Alternatively, in a production factory, a specific use classified into the other productive use may be extracted as an independent use in the case where the specific use occupies a large part of the other productive use.

For example, in a factory that uses a lot of light such as laser light for processing and light sources of inspection apparatuses, the use DB 208 may be configured by defining a classification item “light source use” that is not classified into any of the thermal use, the driving use, the air use, and the vacuum use. To be noted, the light source use mentioned herein corresponds to a use as optical energy necessary for generating ultraviolet light required in a production step of the product instead of illumination lights such as light emitting diodes: LEDs and fluorescent lights for improving the visibility for manual work in general offices and production factories.

In addition, in a facility that includes computational devices such as computers and servers and communication devices in a large scale, such as a data center, the proportion of the energy consumed by electronic devices is larger than in normal production factories. Therefore, the use DB 208 may be configured by providing an independent classification item “electronic device use”. In addition, since the data center is not a production factory, the database may be configured by classifying the uses of the upper hierarchy by names of “infrastructural use” and “data processing use” instead of “infrastructural use” and “productive use”.

As described above, in the information processing apparatus according to the present embodiment, the use DB 208 in which the uses of power consumed in the facility that consumes power are classified is configured. The classification of the uses is commonly (laterally) applied to one or more hierarchies in the facility. The classification items are set in accordance with the content of energy consumption used in the hierarchy, but the number and names of the classification items are not limited by any means.

Incidentally, there are a case where the energy supplied from power distribution equipment such as a distribution board is consumed for a single use (for example, the thermal use) recorded in the use DB 208, and a case where the energy is consumed for a plurality of uses (for example, the thermal use and the driving use). Therefore, in the use DB 208, a distribution ratio defining what percentage of the energy consumption amount obtained at a measurement point such as the distribution board is assigned to the thermal use and what percentage of the energy consumption amount is assigned to the driving use is prepared in advance, and is recorded in association with the use names of the use DB 208. This distribution ratio may be calculated on the basis of the rated power of the equipment as described for the workplace DB 205, or may be calculated on the basis of actual measurement values of a certain time period.

In the case where there is only one use of power supplied from the measurement points, the use DB 208 counts the consumed energy measured in power distribution equipment of the facility such as substations, switchboards, distribution boards, and breakers of the distribution boards by assigning 100% of the measured electric energy to that use. In contrast, in the case where there is a plurality of uses of the electric energy supplied from the measurement points, the use DB 208 counts the measurement values by distributing the measurement values to the workplaces by a predetermined distribution ratio and classifying the measurement values in accordance with the uses.

As described above, even in the case where there is a plurality of uses of the energy measured on the basis of the energy flow at the substations, the switchboards, and the distribution boards, the names of the uses serving as classification items and the distribution ratio for the uses are defined in advance. As a result of this, in the use DB 208 of the present embodiment, the database can be configured by classifying the energy consumption amount in accordance with the use.

In the present embodiment, an added value DB 209 is commonly (laterally) applicable to one or more hierarchies of the facility that consumes power. The added value DB 209 is a database in which the power consumption is classified and recorded in accordance with the added value into which the energy is turned, such as the net, the incident, and the waste. In the added value DB 209, classifications serving as a priority order of energy consumption reduction can be configured in accordance with the content of operation or the content of energy consumption in each hierarchy. The added value DB 209 is related to an operation content DB 210 and a consumption content DB 211 that will be described later, and constitutes Gr. 4 together with these.

For example, in a facility such as a production factory, equipment attributed to a workplace provided in a building or units constituting the equipment consume energy. As a result of this, an operation corresponding to a step such as processing or assembly is performed on a target portion of a material or a part, and thus a target product is produced by giving an added value aimed in the operation. This step can be understood as turning the energy (power consumption) into an added value of the product. In the present embodiment, the energy consumption amount is classified on the basis of the type of added value that is created.

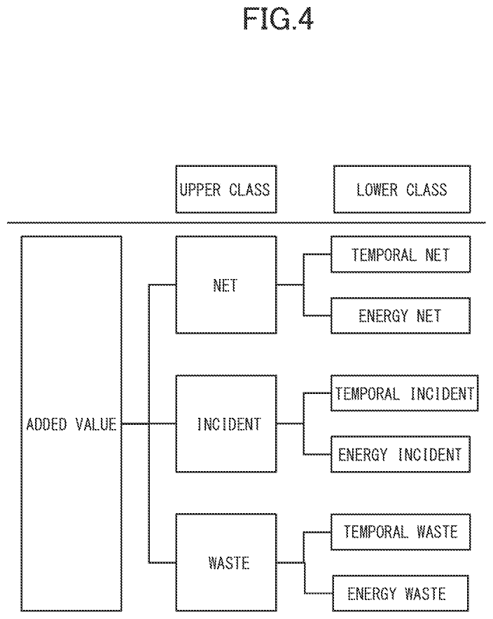

FIG. 4 is a schematic diagram illustrating an example of a classification system used for classification of the added value in the embodiment. In FIG. 4, in an upper hierarchy, the classification items based on the added value are defined as the net, the incident, and the waste for the sake of convenience. The “net” means that the consumed energy is used for directly or effectively giving an added value to a target object (processing target material or part). For example, power consumed by equipment or a unit that is in charge of a step such as processing or assembly can correspond to the net. The “incident” indicates that the consumed energy does not directly give an added value to the target object (processing target material or part), but is necessary in the current use condition of the equipment or unit. The “waste” is a classification item indicating that the consumed energy does not directly give an added value to the target object (processing target material or part) and is not necessary in the use condition.

For example, in the case where the power of the equipment is on and the energy is consumed even though the production is stopped, the equipment is not giving an added value to the product in the aimed operation, and is neither energy consumption necessary for production, and therefore this consumption amount is classified as the waste.

As another example, in the case where the power of equipment such as an electric furnace is on in a time period in which the setup is changed for a different model of product, the energy consumption amount in this time period does not give an added value to the product. However, if the power of the electric furnace is turned off in the time period of setup change, the electric furnace cannot operate at a temperature that guarantees the quality of the product at a timing of production of the product performed immediately after the setup change. Therefore, this energy consumption amount is classified as the incident as an item that does not directly create an added value but is necessary in the current use condition.

In contrast, for example, in a time period in which a target part is charged into an electric furnace and heated and melted, the energy consumption is classified as the net because the energy consumption is turned into melting, which is an added value to the target part.

In FIG. 4, the “net” serving as one classification in the upper hierarchy is classified into the “temporal net” and the “energy net” in a lower hierarchy. In addition, the “incident” is classified into the “temporal incident” and the “energy incident”, and the “waste” is classified into the “temporal waste” and the “energy waste” in a lower hierarchy. According to the classification in the lower hierarchy, the net, the incident, and the waste can be further classified into, for example, the temporal net, the temporal incident, and the temporal waste on the basis of the details of the operation content in each time period. Alternatively, the energy consumed by an operation performed by a unit constituting equipment can be further classified into, for example, the energy net, the energy incident, and the energy waste on the basis of the content of the energy consumption.

In the present embodiment, on the basis of the classification items of the operation content DB 210 or the consumption content DB 211 of FIG. 1 and the relationship thereof with the added value DB 209, the classification items of Gr. 4 are associated with each other, and the operation content and the energy consumption content are classified in accordance with the type of the added value. Specific examples will be given below.

In the present embodiment, the operation content DB 210 is a database for classifying the consumed energy of the facility that consumes energy on the basis of the details of the operation content of each time period of one or more of the workplace, equipment, and unit. Specifically, the consumed energy is classified in accordance with the type and level of value. For example, the consumed energy is classified in accordance with whether or not the consumed energy gives an added value to the target part, whether or not the consumed energy does not give an added value but is necessary in the current use condition of the facility, and whether or not the consumed energy does not give an added value and is not necessary in the current use condition. The operation content DB 210 is a database for the classification processing portion 3 to refer to when classifying the consumed energy on the basis of these added values.

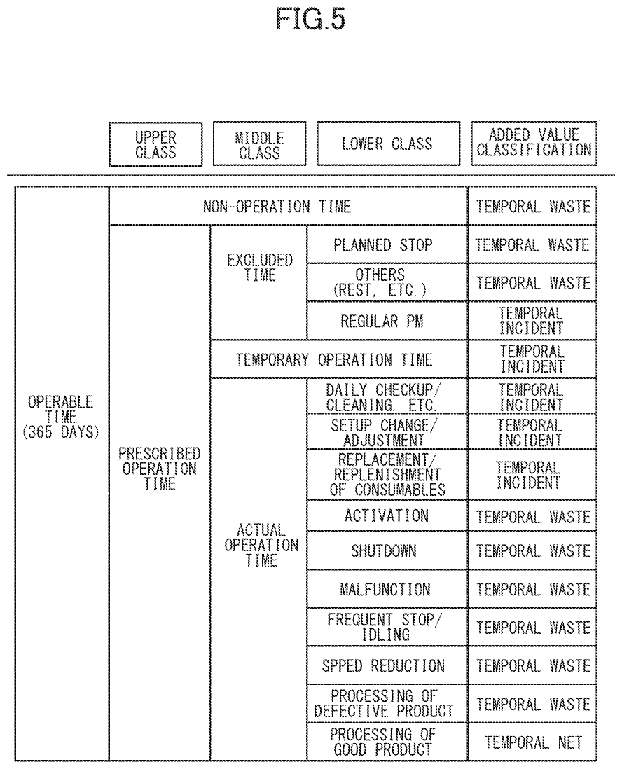

FIG. 5 illustrates an example of classification items hierarchically configured in the present embodiment. FIG. 5 is a schematic diagram hierarchically illustrating an example of items for classifying the operable time for each time period. These hierarchical classification items can be applied to, for example, the workplaces, equipment, and units in the facility that consumes power. In the present embodiment, the operable time of the facility is classified into a prescribed operation time and a non-operation time in the upper hierarchy. The prescribed operation time is further classified into an excluded time, a temporary operation time, and an actual operation time in a middle hierarchy. Further, the excluded time is classified into a planned stop, others (rest and the like), and regular PM (plant maintenance: PM) in the lower hierarchy. In addition, in the lower hierarchy, the actual operation time is classified into daily checkup/cleaning, setup change/adjustment, replacement/replenishment of consumables, activation, shutdown, malfunction, frequent stop/idling, speed reduction, processing of defective products, and processing of good products. To be noted, in the case where the classification is the same for each of the upper, middle, and lower hierarchies, for example, in the case of the non-operation time, since the classification is the same for all the hierarchies, the classification frame is integrated into one in the illustration of FIG. 5. The hierarchical classification illustrated in FIG. 5 is merely an example, and it goes without saying that the classification can be appropriately changed in accordance with the content of operation.

As described above, in the present embodiment, the details of the operation content of each time period are hierarchically classified from the upper to lower hierarchies. In the case where each lower-class classification is associated with the classification of the added value of FIG. 4, the added value classification as illustrated on the right end of FIG. 5 is obtained. For example, energy consumed in the non-operation time does not give an added value and is not necessary in the current use condition of the facility, and is therefore classified as the waste. Similarly, energy consumed in the time for replacement/replenishment of consumables does not give an added value but is necessary in the current use condition of the facility, and is therefore classified as the incident. The energy consumed in the time for processing a good product gives an added value to a target part such as a material or part, and is therefore classified as the net.

As described above, according to the present embodiment, the consumed energy is classified on the basis of the added value, and thus the database can be configured. In this manner, the energy classified into the net, the incident, and the waste in the upper hierarchy of the added value DB 209 can be further classified into the temporal net, the temporal incident, and the temporal waste in association with the details of the operation content of each time period recorded in the operation content DB 210.

In the present embodiment, the consumption content DB 211 is a database for classifying the consumed energy of the facility that consumes power on the basis of the type of operation performed on the target part such as processing or assembly by one or more of the equipment and units. Specifically, the energy consumed by the equipment or units is classified in accordance with whether or not the consumed energy gives an added value to the target part, whether or not the consumed energy does not give an added value but is necessary in the current use condition of the facility, and whether or not the consumed energy does not give an added value and is not necessary in the current use condition. The consumption content DB 211 is a database for the classification processing portion 3 to refer to when classifying the consumed energy on the basis of these added values.

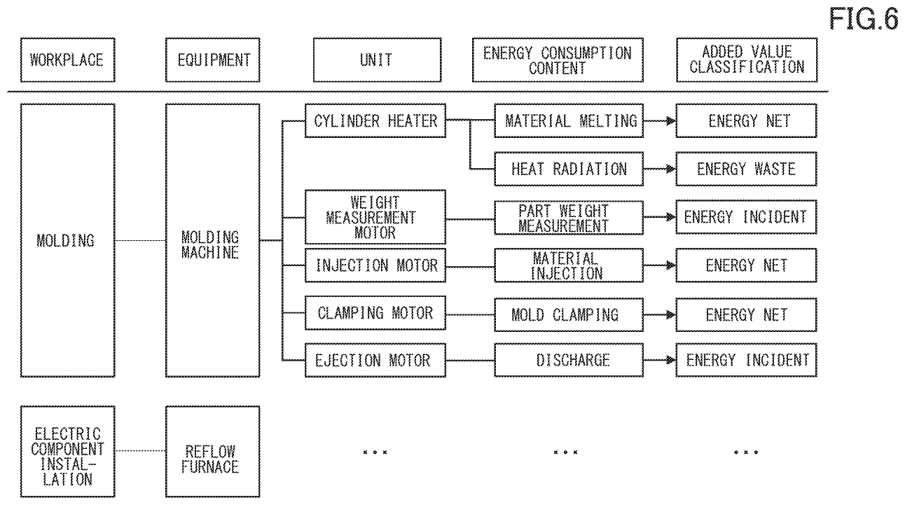

FIG. 6 illustrates another example of hierarchical classification items in the present embodiment. FIG. 6 is a schematic diagram illustrating an example of classification items used for classifying the energy consumption content for an operation performed by equipment or units in the facility. In FIG. 6, an operation of a unit constituting equipment performs while consuming energy is classified into a hierarchy of energy consumption content.

For example, the cylinder heater of the molding machine is in charge of an operation of melting the material. The energy consumed in this operation can be classified into energy directly used for melting the material and energy radiated from the unit in the melting process. Therefore, the energy consumption content of the cylinder heater is classified into material melting and heat radiation. Further, if the classification of added value of FIG. 4 is associated with each of the energy consumption contents, the classification is as illustrated in the hierarchy of added value classification of FIG. 6. For example, the energy classified into the material melting is classified as the energy net because this energy gives an added value, that is, “melting” to the material. In contrast, the energy classified into heat radiation is merely dissipation of heat from the cylinder heater, which does not add a value to the material and is not necessary in the current use condition, and is therefore classified as the energy waste.

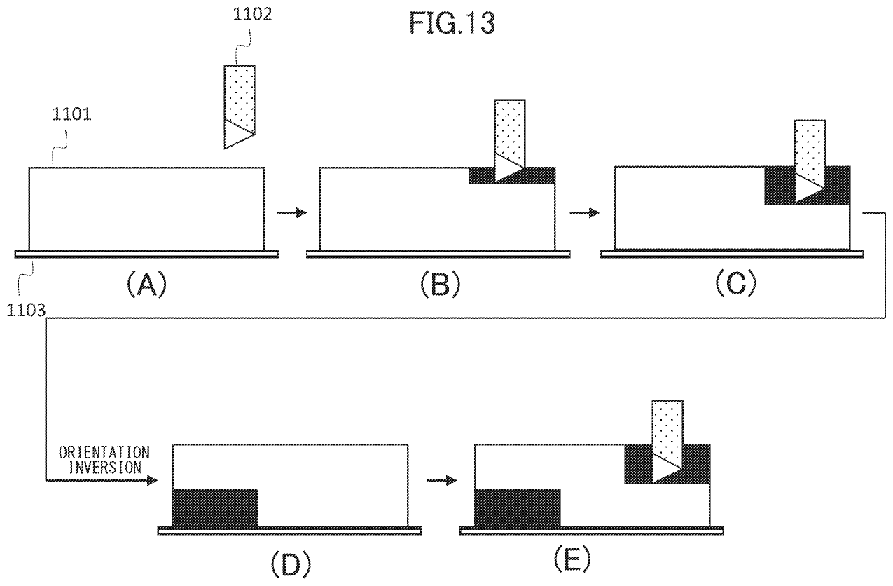

As another specific example, an example of a cutting process will be described. FIG. 13 illustrates an operation of a cutting processing apparatus shaving off a target material in the cutting process stepwise. In this apparatus, a material 1101 is disposed on a stage 1103. When the process is started, a cutting tool 1102 is set to a predetermined position with respect to the material 1101 in step (A), a cutting operation is performed in step (B), and after cutting of a specific portion is finished in step (C), the orientation of the material is inverted to cutoff another portion in step (D). In a general cutting processing apparatus, this inversion operation is performed by a worker gripping and inverting the material. After the material 1101 is inverted, the cutting tool 1102 cuts off a target portion in step (E), thus a product having an aimed shape is completed, and thus the cutting process is completed.

Regarding this series of steps, the classification processing portion 3 classifies the consumed energy from the viewpoint of the operation content in each time period and from the viewpoint of the energy consumption content of the operation performed by units constituting equipment. The energy classified from the viewpoint of the operation content in each time period is associated with one of the temporal net, the temporal incident, and the temporal waste illustrated in FIG. 4. In contrast, the energy classified from the viewpoint of the energy consumption content is associated with one of the energy net, the energy incident, and the energy waste illustrated in FIG. 4.

First, the standard for the classification processing portion 3 to classify the measured consumed energy in accordance with the details of the operation content of each time period will be described. In the case where a good product satisfying the quality criteria is obtained in the steps described with reference to FIG. 13, since energy is consumed in a time period in which an added value is given to the material, the classification processing portion 3 classifies the energy as the temporal net as illustrated in FIG. 5. In the case where a defective product is obtained, since the defective product does not give an added value and is not necessary in the production activity in the current condition, the classification processing portion 3 classifies the energy as the temporal waste. In contrast, energy consumed by idling by the apparatus during a time period in which the part number is changed and the setup is changed to perform a cutting process of a part of a different shape is necessary in the current condition but does not give an added value to the material, and therefore the classification processing portion 3 classifies the energy as the temporal incident.

Next, the standard for the classification processing portion 3 to classify the measured consumed energy in accordance with the energy consumption content will be described. Energy consumed by a processing motor that is a constituent unit of a cutting apparatus to cause the cutting tool to cut the material is classified as the net. This is because this step gives an added value that the material is cut and processed into an aimed shape.

For example, to give the raw material a function as a bracket serving as a support part for coupling two parts, the raw material needs to be processed into an S shape as illustrated in (E) of FIG. 13 because the initial rectangular parallelepiped shape illustrated in (A) of FIG. 13 does not satisfy the aimed function. Therefore, the classification processing portion 3 classifies the operation of the cutting processing apparatus as a net operation, determining that an added value is given to the material by the energy for the processing. Further, the consumed energy of the cutting processing apparatus required in this operation is classified as the energy net.

In the orientation inversion performed between steps (C) and (D), the cutting tool is temporarily moved away from the material, then the stage is moved to a position for orientation control, and then the worker manually inverts the orientation of the material. The energy used for driving the stage at this time is necessary in the current apparatus configuration but does not directly give an added value like a removal processing performed for achieving the purpose, and therefore the classification processing portion 3 classifies this energy as the energy incident.

In addition, in the case where the cutting tool is idled in rotation while the worker performs the orientation inversion, the good product processing time is further classified into finer categories. The energy consumed by the apparatus during idling is not necessary in the current apparatus configuration and is not necessary for production, and therefore the classification processing portion 3 classifies this energy as the energy waste.

In addition, in the case where the cutting tool is rotated by a motor in a state of being not in contact with the material in a time between steps (A) and (B), this idling rotation is an operation necessary for the cutting tool to reach a desired rotation speed from a non-moving state. Therefore, the classification processing portion 3 classifies the energy consumed in this idling rotation as the energy incident. In this manner, the energies classified into the net, the incident, and the waste in the upper hierarchy of the added value DB 209 can be classified into more divisions in association with the energy consumption content of the operation of the unit recorded in the consumption content DB 211.

Specifically, the energy net, the energy incident, and the energy waste can be extracted as partial elements constituting the net, the incident, and the waste. By combining this classification according to the energy consumption content with the classification based on the details of the operation content in each time period described above, as illustrated in FIG. 4, the net of the upper classification (upper hierarchy) can be further classified into the temporal net and the energy net. Similarly, the incident of the upper classification can be further classified into the temporal incident and the energy incident, and the waste of the upper classification can be further classified into the temporal waste and the energy waste.

In addition, although the units and the energy consumption content are classified in association in FIG. 6, the equipment and the energy consumption content may be classified in association. For example, in the case of equipment constituted by a single unit, the granularity of the equipment (unit for distinguishing each piece of equipment) and the granularity of the unit (unit for distinguishing each unit) are equal, the equipment and the energy consumption content can be directly associated. Meanwhile, even in the case of equipment constituted by a plurality of units, if the operation thereof is roughly classified, the measured consumed energy may be classified into the energy net, the energy incident, and the energy waste on the basis of the energy consumption content of the operation of the equipment as a whole.

As described above, according to the present embodiment, each DB constituting Gr. 2 of the energy use condition input portion 2 illustrated in FIG. 1 and each DB constituting Gr. 4 can be associated with each other, and thus the measured consumed energy can be classified. That is, the consumed energy is classified by associating the building DB 204, the workplace DB 205, the equipment DB 206, and the unit DB 207 classified into Gr. 2 and the added value DB 209, the operation content DB 210, and the consumption content DB 211 classified into Gr. 4 with each other.

According to this configuration, first, the consumed energy can be vertically classified in accordance with items (for example, workplaces, equipment, and units) in a hierarchy in the operation system of the facility. Further, the consumed energy can be laterally classified in accordance with the level of the waste (for example, the net, the incident, and the waste) on the basis of the items of added value associated with the operation content or the energy consumption content of each time period in these hierarchies.

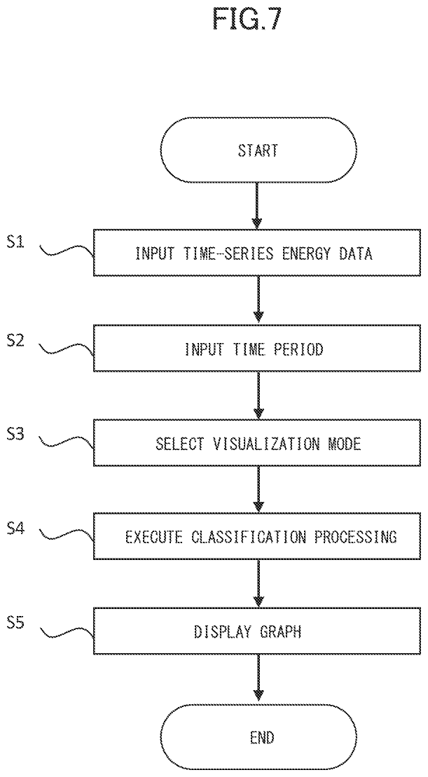

Next, a processing flow of the classification processing portion 3 classifying the energy consumption amount input to the energy consumption amount input portion 1 on the basis of a plurality of items recorded in the energy use condition input portion 2 and displaying the processing results will be described with reference to the flowchart of FIG. 7 and the block diagram of FIG. 1.

In step S1, the information processing apparatus of the present embodiment receives input of energy data from the user, and thus obtains the energy data. The user inputs the energy data from an energy management system (EMS) provided in the building, a current sensor, or an electric energy meter provided in the equipment to the energy consumption amount input portion 1. The input data is electric energy data in time series, and is, for example, recorded in the unit of kWh. Regarding the temporal resolution for recording the energy data, electric energy data measured per second, per minute, per hour, per day, per month, or the like is input. Alternatively, the energy information processing apparatus and the EMS provided in the facility may be connected to each other on a server such that the energy data in time series obtained at the distribution boards is automatically input. Similarly, a configuration in which energy data obtained by a current sensor provided in the equipment or an electric energy meter provided in the equipment is automatically input to the energy consumption amount input portion 1 may be employed.

Next, in step S2, the information processing apparatus of the present embodiment receives input of a time period from a user, and thus obtains information about the time period. The user inputs information about a time period indicating the energy consumption amount of which time period in the time-series energy data is to be visualized. As the time period, an arbitrary period such as one year, one month, one week, one day, one hour, one minute, or the like can be specified in accordance with the purpose. For example, by visualizing (displaying) the total consumption amount in one year, an insight on the overall energy consumption of the facility may be obtained. In the case where the range of the time period is set to one year, the granularity of the scale displayed in the time-series graph may be set to one month to display monthly transition. Alternatively, the time period may be set to two weeks and the granularity of the scale may be set to one week to visualize (display) the comparison between the previous week and the current week on the energy consumption amount. According to this configuration, the PDCA (plan, do, check, and action) cycle of the energy consumption reduction activity of each workplace can be executed each week. Alternatively, by setting the range of the time period to one hour and setting the granularity of the scale to one second, the transition of the energy consumption amount can be tracked in real time.

Next, in step S3, the information processing apparatus of the present embodiment receives selection of a visualization mode from the user, and obtains information about selection of the visualization mode. The user selects the visualization mode in accordance with the purpose regarding on the basis of which classification item the consumed energy is to be analyzed in the energy use condition input portion 2 illustrated in FIG. 1. If the data input to the EMS is used as it is, the energy consumption amount (electric energy) in the period selected by the user can be visualized for each substation, each switchboard, and each distribution board by using the data of the selected temporal resolution. The information processing apparatus of the present embodiment is characterized by reconfiguring the energy data by classifying the data in accordance with the classification items of the classification groups Gr. 2, Gr. 3, and Gr. 4. For this classification processing, a plurality of classification items is prepared in advance in the database. Therefore, information about for what kind of analysis the consumed energy is to be visualized, which serves as the basis for the classification, is specified. In the present embodiment, this specification of the classification conditions will be referred to as a visualization mode for the sake of convenience.

For example, in the case of reconfiguring the energy data on the basis of the two classification items of the workplace DB 205 of Gr. 2 and the use DB 208 of Gr. 3, the visualization mode is configured as a visualization mode for each workplace and each use. In this mode, the energy consumption amount is visualized for each workplace recorded in the workplace DB 205, and the same energy consumption amount is visualized for each use.

Next, in step S4, the information processing apparatus of the present embodiment executes the classification processing of the energy consumption amount on the basis of the visualization mode selected in step S3. For example, in the case of the visualization mode for each workplace and use, the classification processing portion 3 classifies the energy consumption amount attributed to the classification of the workplace information recorded in the workplace DB 205, that is, each item of the workplace names such as the molding workplace, the electric component installation workplace, the fixing belt workplace, the automatic assembly workplace, the manual assembly workplace, and the like of FIG. 2. As calculation processing for processing this classification, for example, calculating the distribution of the energy consumption amount of one distribution board by using the distribution ratio recorded in association with the workplace names of the workplace DB 205, or the sum of the energy consumption amounts of a plurality of distribution boards is calculated.

Next, the classification processing portion 3 executes classification of the use information recorded in the use DB 208. That is, the energy consumption amount is classified on the basis of each item of uses such as the infrastructural use and the productive use in the upper hierarchy in FIG. 3, and the illumination use, the air conditioning use, the other infrastructural use, the thermal use, the driving use, the air use, the vacuum use, and the other productive use in the lower hierarchy. As calculation processing for this classification, for example, the distribution of the energy consumption amount of one distribution board is calculated by using the distribution ratio recorded in association with the use names of the use DB 208, or the sum of the energy consumption amounts of a plurality of distribution boards is calculated.

According to this configuration, the energy consumption amount attributed to the molding workplace and the thermal use can be output as numerical data on the basis of the two classification items of the workplace and the use. In the information processing apparatus of the present embodiment, the classification processing portion 3 classifies the energy data similarly for the other workplaces and uses, and the reconfigured energy data is output to the display portion 4.

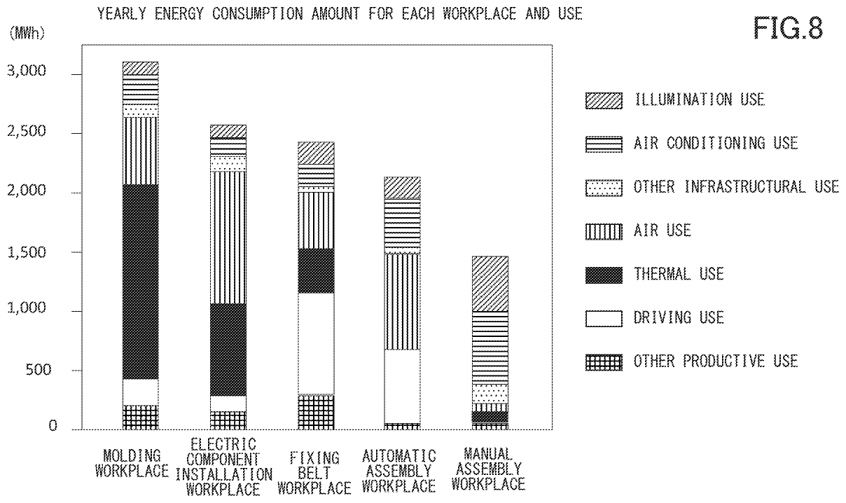

Next, in step S5, the information processing apparatus of the present embodiment generates a graph of the energy data classified by the classification processing portion 3 for, for example, each workplace, and the graph is displayed on the display portion 4. For example, as illustrated in FIG. 8 as an example, a graph is generated and displayed such that the user can easily understand in which workplace and for which use the energy consumption amount is large. FIG. 8 is a graph of the energy consumption amount for each workplace and use visualized as a cumulative bar chart, and indicates the yearly energy consumption amount of a production factory. In FIG. 8, the horizontal axis indicates the classification of the workplace, the vertical axis indicates the classification of the use, and energy for which use is consumed yearly in each workplace is displayed in an easily identifiable manner by using textures such as horizontal lines and diagonal lines. Although the identifiability is improved by using the texture of the graph in this example, the display mode in the present embodiment is not limited to this, and for example, each use may be displayed in a different color to be distinguished. In addition, as the time period, an arbitrary time period selected in step S2 in accordance with the purpose of the energy consumption reduction activity may be used.

Although an example of visualizing a specific time period has been illustrated in FIG. 8, the user may input two different time periods, the classification processing portion 3 may select the energy consumption amount corresponding to each time period, and the energy consumption amount may be displayed on the display portion 4. In addition, although an example in which the number of the workplaces is 5 has been described for the sake of convenience of description, the number of the workplaces may be larger in the case of, for example, a large-scale production factory. In addition, the use is not limited to the described example, and for example, the uses such as the vacuum use, the light source use, and the electronic device use from the other productive use may be extracted and described as classification items in parallel with the thermal use, the driving use, the air use, and the like.

In FIG. 2, a case where the facility is constituted by a plurality of buildings, and a plurality of workplaces are provided in each building is illustrated as an example. In such a case, the energy consumption amount of each workplace is counted within the range of each building, and the energy consumption amount may be displayed for each building. In addition, in FIG. 2, the workplace has a hierarchical structure in which there are a hierarchy of the processing workplace and the assembly workplace, and there is a hierarchy of the molding workplace, the electric component installation workplace, and the fixing belt workplace under the processing workplace. At this time, the energy consumption amount may be classified and visualized in the hierarchy of the molding workplace, the electric component installation workplace, and the fixing belt workplace, or the energy consumption amount may be visualized in the hierarchy of the processing workplace and the assembly workplace, which is an upper hierarchy. In some facilities, there may be a hierarchy of organization such as departments and divisions, and the energy consumption amount can be similarly classified and displayed by arbitrarily selecting the hierarchy of divisions or departments. Alternatively, the unit of classification of the energy consumption amount may be determined for visualization in accordance with the concept of locations instead of organizations, such as the entirety of the first floor of the A1 building including the molding workplace and the entirety of the second floor of the A1 building including the electric component installation workplace. Alternatively, the energy consumption amount may be visualized for each area in a specific floor by defining partial ranges in the first floor of the A1 building as a first area, a second area, and the like. As described above, the energy consumption amount can be visualized in each hierarchy of an arbitrary organization or location exemplified in FIG. 2.

The user can comprehensively grasp the overall energy consumption amount of the facility by referring to the graph of the energy consumption amount classified for each workplace and use as exemplified in FIG. 8. Further, in which workplace the energy consumption amount is large in the facility can be grasped, and thus the priority order for the energy consumption reduction activity can be determined. For example, in the visualization result of FIG. 8, the energy consumption amount is in the order of the molding workplace, the electric component installation workplace, the fixing belt workplace, the automatic assembly workplace, and the manual assembly workplace with the energy consumption amount in the molding workplace being the largest. Therefore, when reducing the energy consumption, a greater reduction effect can be obtained in a shorter time by charging the workforce and money serving as resources of the reduction activity to the molding workplace with a higher priority.

If only the consumption amount based on the energy flow measured at each piece of power distribution equipment such as the distribution board is visualized, the priority order for the workplaces cannot be determined. Therefore, for example, also an organization (activity unit) whose energy consumption amount is small, such as the manual assembly workplace, also has to work on the reduction activity, which can lead to less concentration of the limited resource. In contrast, by using the information processing apparatus of the present embodiment, such deterioration of the investment efficiency can be suppressed.

In FIG. 8, a case where the horizontal axis represents the workplaces input to the workplace DB 205 and the vertical axis represents the energy consumption amount is illustrated as an example. As another example, since the time-series data of the energy consumption amount is input to the energy consumption amount input portion 1, the horizontal axis may represent the time, the vertical axis may represent the energy consumption amount, and the transition of the energy consumption amount in an arbitrary organization hierarchy may be displayed.

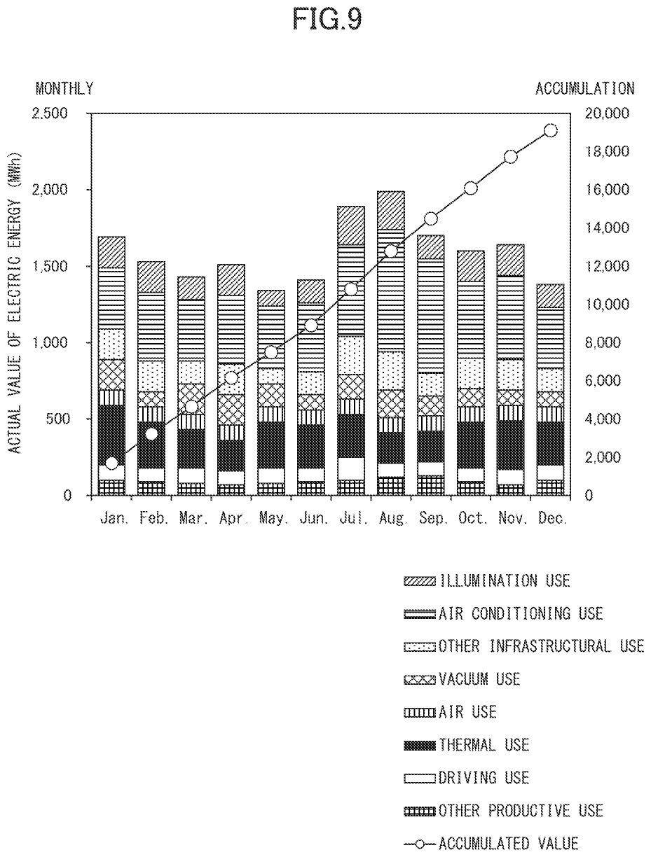

FIG. 9 is a diagram illustrating the transition of the energy consumption amount of the entirety of the facility serving as a target of visualization. The horizontal axis represents the month, and the actual values of the energy consumption amount in each month are displayed. The first vertical axis on the left side of FIG. 9 represents the actual values of the energy consumption amount in each month, and the energy consumption amount is displayed as a cumulative bar chart for each use. The second vertical axis on the right side of FIG. 9 represents the accumulation of the actual values of the energy consumption amount, and the accumulation is displayed as a line graph. For example, the point of February in the line graph is the sum of the actual values of January and February, and the point of December is the sum of the actual values from January to December. According to this display, the transition of the actual energy value of an arbitrary organization can be easily grasped by the user for each use.

Although the overall energy consumption amount of the facility is selected and displayed in FIG. 9, a hierarchy of a specific workplace such as the molding workplace may be selected. In addition, although the unit of the horizontal axis is month, the granularity of the time may be finer to display the transition of the energy consumption amount in the unit of day, hour, minute, second, or the like. If data updated in real time more frequently than every second is input to the energy consumption amount input portion 1, the display portion 4 can also track and display the transition of the energy consumption amount of an arbitrary piece of equipment in real time. In addition, the selection of the equipment is not limited to only one piece of equipment, and a plurality of pieces of equipment may be selected and simultaneously displayed to compare the transition of energy consumption amount between different pieces of equipment.

Alternatively, the transition of planned values may be displayed by inputting planned values instead of inputting the actual values of the energy consumption amount to the energy consumption amount input portion 1. Further, the classification processing portion 3 may select both the planned values and the actual values, and thus the planned values and the actual values may be displayed on the display portion 4 such that these can be compared with each other. In this manner, for example, whether or not the actual values of the energy consumption amount are within the range of a plan of the energy consumption amount made in the beginning of the year can be easily checked. For example, in the case where the accumulated value in June of that fiscal year that is displayed in June is larger than the planned value, the plan can be adjusted to reduce the consumption amount in the period from July to December of that year such that the accumulated actual value in December is within the plan made in the beginning of the year. In this manner, the plan and actual values of the energy consumption amount can be managed.

To analyze a part where the priority in the energy consumption reduction activity is high, the user can return to step S3, and can select the visualization mode for each piece of equipment and operation content for a workplace such as the molding workplace which has a large energy consumption amount and is thus high in the priority order. When the visualization mode for each piece of equipment and operation content is selected, the classification processing portion 3 of FIG. 1 refers to the classification of the equipment information recorded in the equipment DB 206 and the time-series energy data input to the energy consumption amount input portion 1. The classification processing portion 3 extracts the energy data for each piece of equipment obtained by the equipment including a current sensor or an electric energy meter from the energy data that is referred to. For example, in the case of reducing the waste of the energy in the molding workplace, the energy data of the 1000-t molding machine of FIG. 2 is selectively extracted. Then, the energy of the 1000-t molding machine is classified for each operation content on the basis of the details of the operation content of each time period recorded in the operation content DB 210 illustrated in FIG. 5.

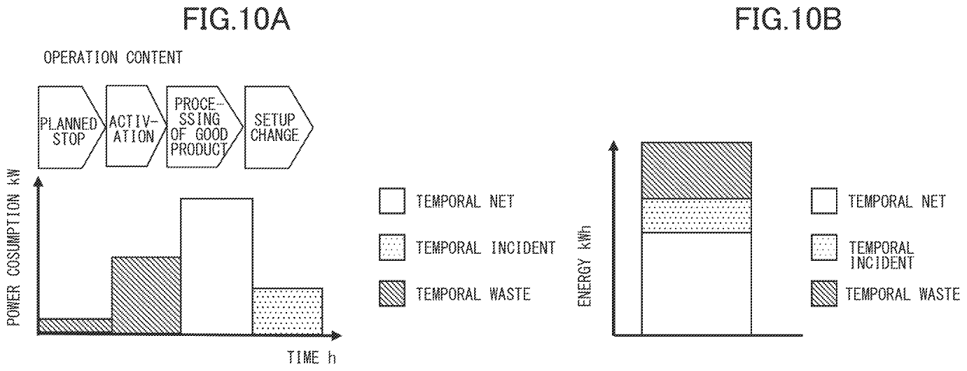

Next, in step S4, the information processing apparatus executes the classification processing by using the added value in the added value DB 209 whose relationship with the operation content is defined in advance. FIGS. 10A and 10B illustrate an example of visualization for each piece of equipment and operation content classified in the visualization mode for each piece of equipment and operation content and output by the display portion 4.

FIG. 10A is a graph for each piece of equipment and operation content in which the vertical axis represents the power consumption (kW), the horizontal axis represents the time (h), and the consumed energy of the 1000-t molding machine in time series is indicated by the area expressed by power consumption (kW)×time (h)=electric energy (kWh). When the hierarchical classification items of FIG. 5 are applied, the energy consumed by the 1000-t molding machine in the time period of planned stop and activation is classified as the temporal waste, that is, classified as the waste on the basis of the details of the operation content of each time period. In addition, the energy in the time period of the good product processing is classified as the temporal net, and the energy in the time period of the setup change is classified as the temporal incident, respectively.

In addition, FIG. 10B illustrates a cumulative bar chart in which the level of waste is classified for each time period in FIG. 10A is counted as the total consumption amount of the 1000-t molding machine. As a result of this, the waste energy amount consumed by a specific piece of equipment in a certain period can be counted.

As described above, according to the information processing apparatus of the present embodiment, the level of the waste in the energy consumed by a specific piece of equipment in a certain time period can be analyzed on the basis of the added value, and therefore the user can execute a prioritized reduction measure. For example, as a result of visualization of the graph of FIG. 10A, it can be easily understood that the energy in the time period of the planned stop and the activation is “temporal waste” that does not give an added value to the material and is not necessary in the condition using the current equipment. Therefore, the user can immediately execute a measure such as turning the power off in that time period.

Such a measure has a higher investment efficiency in terms of time and cost than a measure such as reducing the “temporal incident” in the time period of the setup change by changing the design of the injection molding machine to a more energy-saving configuration or reducing the “temporal incident” in the time period of the setup change by suppressing heat radiation by using a thermally insulating material. As a result of visualization of the analysis result, in this example, the user can determine to remove the temporal waste ahead of the temporal incident, and thus can execute a reduction activity having a high investment efficiency with a higher priority.

Alternatively, on the basis of the visualization result of FIG. 10B, in the amount of energy consumed by the 1000-t molding machine in a certain time period, the user can easily determine that since the amount of the temporal waste is larger than the temporal incident, the temporal waste should be reduced with a higher priority. As described above, the information processing apparatus of the present embodiment can provide and display information related to the determination criteria for reducing the waste of the energy consumption amount by setting the priority order in the reduction measures.

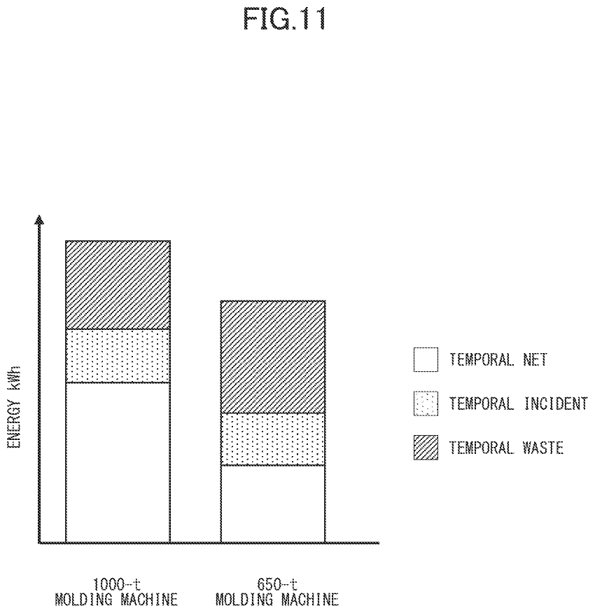

Although the visualization result of a single piece of equipment, which is the 1000-t molding machine, is illustrated as a cumulative bar chart in FIG. 10B, cumulative bar charts of a plurality of pieces of equipment may be arranged side by side as illustrated in FIG. 11 to compare the amount and proportion of the net, the incident, and the waste, between the pieces of the equipment. For example, a graph of a 1000-t molding machine and a graph of a 650-t molding machine may be arranged side by side for comparison. Alternatively, the classification results of the net, the incident, and the waste related to a plurality of molding machines such as the 1000-t molding machine and the 650-t molding machine may be added up, and the sum may be displayed in a cumulative bar chart as a classification result of the molding workplace, which is in a higher hierarchy than the equipment.

To be noted, although the operation content DB 210 is configured by, for example, classifying the time period for setup change as the temporal incident in the details of the operation content of each time period illustrated in FIG. 5, this time period may be further divided into a setup change within a standard time and a setup change out of a standard time. The standard time is a time set for each apparatus in the workplace in advance as a time within which the setup change should be completed. The operation content DB 210 may be configured such that setup change within the standard time is classified as the temporal incident and the setup change out of the standard time is classified as the temporal waste in the case where the setup change takes a longer time than the standard time. Similarly, activation, shutdown, regular PM, daily checkup/cleaning, adjustment, and replacement/replenishment of consumables may be divided into within the standard time and out of the standard time, and within the standard time may be classified as the temporal incident and out of the standard time may be classified as the temporal waste.

By setting the standard time in this manner, a threshold value for determination regarding the temporal incident or the temporal waste in accordance with the characteristics of the workplace and equipment can be adjusted. For example, a standard time for activation is set in advance for an apparatus whose temperature needs to be stabilized by taking a certain time before starting the processing, and the classification processing portion 3 classifies this time as the temporal incident. If the standard time is exceeded, the classification processing portion 3 can perform detailed analysis that this is not caused by the apparatus but is temporal waste resulting from elongated activation time caused by human operation error or the like. Alternatively, the threshold value for the classification of the operation time may be adjusted such that for an apparatus whose activation before the processing is immediately completed when the power is turned on, the standard time is set to 0, and all the activation time is set to the waste.

As another example, the energy consumption reduction measure in the case of a cutting process will be described. The energy consumed by idling of the cutting processing apparatus in a time period in which the setup change is performed is classified as the temporal incident in the information processing apparatus of the embodiment. By checking the result of visualization by the information processing apparatus, the user can determine that the energy of the temporal incident can be reduced by reducing the setup change time.

For example, it can be determined that, in the good product processing time before the setup change, organizing the material for the next part number in advance to be easier to charge into the apparatus can be a measure to reduce the energy consumption. Alternatively, there is a case where many types of products are produced and manual work requires a lot of setup changes and thus takes a lot of time. In such a case, it can be determined that in the case where the cutting processing apparatus is equipped with an automatic conveyance apparatus, the energy consumed by the automatic conveyance apparatus is smaller than the energy consumed by idling. As a result of this, the energy of the temporal incident can be reduced.

Alternatively, by checking the result visualized by the information processing apparatus, the user can determine that improving the good product ratio of the part produced by the cutting processing machine is effective for reducing the temporal waste that is an energy consumed for processing of a defective product. Although the energy of one piece of equipment is classified in the visualization mode for each piece of equipment and operation content in the present embodiment, the energy of a plurality of pieces of equipment such as the 1000-t molding machine and the 650-t molding machine may be classified and visualized (displayed) for each piece of equipment. The user may determine which energy should be reduced with a higher priority by comparing these energies on the basis of the visualized graph. In addition, since the user can arbitrarily select the measurement period, for example, one week may be selected to compare the operation content of the current week with the previous week, or one year may be selected for comparison in a long-term perspective. In addition, the graph of the energy data of the equipment may be visualized in a unit time, for example, 1 second, which is shorter than the temporal resolution illustrated in FIG. 10A.

In the visualization mode for each piece of equipment and operation content, the classification processing portion 3 can classify the energy of a plurality of pieces of equipment for each operation content, but generally, in production equipment, a plurality of pieces of equipment are often operated as an integral group. For example, in the case of a molding machine, not only the body of a 650-t molding machine is operated but also a series of accessory equipment such as a mold temperature adjuster for the 650-t molding machine and a plastic material drier for the 650-t molding machine is also provided and operated together with the body of the 650-t molding machine. In such a case, the details of the operation content of each time period may be recorded individually for the three types of equipment in the operation content DB 210, but these pieces of equipment are operated to process the same part, and therefore the operation contents thereof end up being the same. Therefore, among equipment names recorded in the equipment DB 206, a group of pieces of equipment whose operation content for each time period is the same may be collected as an equipment group (equipment Gr.) and recorded in the equipment DB 206. Similarly, the classification processing portion 3 may classify the operation content of the equipment group by recording the collective operation content also in the operation content DB 210 and associating the equipment DB 206 with the operation content DB 210. Alternatively, the equipment group and individual pieces of equipment may be both recorded in the equipment DB 206 such that the classification processing can be performed on both the individual pieces of equipment and the equipment group.

In this manner, the efficiency of the classification processing in the case where the operation content of each time period is the same can be improved. Alternatively, there is a workplace for which only the operation content of each time period of the 650-t molding machine is recorded. In this workplace, even if the operation content of the accessory equipment such as the mold temperature adjuster and the plastic material dryer is not recorded, the classification processing can be executed for the equipment group on the basis of the fact that these pieces of equipment operate together.

Next, the user selects the visualization mode for each unit and consumption content for the energy classified as the temporal net as a result of the mode described above, and executes the classification processing and the graph display in a similar manner to the flow described above. That is, the information processing apparatus of the embodiment receives selection of the visualization mode by the user, and executes the classification processing and the graph display in accordance with the selected mode.

The classification processing portion 3 of FIG. 1 refers to the classification items recorded in the unit DB 207 and the consumption content DB 211. Then, the classification processing portion 3 further classifies the energy consumption amount classified as the temporal net in the classification results visualized for each piece of equipment and operation content, which is the visualization mode of the previous stage, on the basis of the classification items that are referred to. Specifically, the classification result described above is classified on the basis of the type of the energy consumption content of the energy consumed by the operation performed on a target part by a unit.

In the visualization mode for each unit and consumption content, the energy data measured by a current sensor or an electric energy meter provided in the unit is input to the energy consumption amount input portion 1 for each unit constituting the 1000-t molding machine such as the cylinder heater and the weight measurement motor. The classification processing portion 3 extracts only the energy consumption amount classified as the temporal net in the energy data visualized in the visualization mode for each piece of equipment and operation content described above. At this time, the energy of the temporal net is accumulated in mutual association with the energy data measured for each unit on the database. That is, the consumed energy classified as the temporal net can be re-classified regarding in which unit the energy has been consumed. As a result of this, more detailed classification in accordance with the type of the added value can be performed in accordance with the energy consumption content of the operation of each unit illustrated in FIG. 6.

For example, the energy consumed by melting the material by the cylinder heater is energy that has directly acted to change the state of the processing target object, thus gives an added value to the material, and therefore is classified as the energy net. Energy dissipated into the air due to heat radiation does not give an added value and is not necessary in the current condition, and is therefore classified as the energy waste. Energy consumed by measuring the weight of the part does not give an added value but is necessary in the current condition, that is, in the current equipment configuration, and is therefore classified as the energy incident.

In FIG. 6, the operation of melting performed by the cylinder heater is associated with two energy consumption contents that are the material melting and heat radiation. This is because even one operation of a unit can be classified into two energy consumption contents. In such a case, the energy corresponding to the energy net is calculated as a theoretical value from a theoretical formula of the thermal energy needed for the melting. Next, a difference obtained by subtracting the theoretical value from the energy consumption amount measured for each unit is classified as the energy waste resulting from the heat radiation.

For example, in the case of performing detailed classification regarding melting, the energy net can be obtained by using the formula (1) below.

Q=mcΔT (1)
where
Q represents energy (J) required for the melting,
m represents the mass (kg) of the material,
c represents the specific heat (J/kg-K) of the material, and
ΔT represents the temperature change (K) required for the melting.

Alternatively, in the case of performing detailed classification for, for example, conveyance equipment as a unit attributed to the driving use, the energy net can be obtained from the kinetic energy required for conveyance of the part by using the formula (2) below.

E=1/2mv² (2)
where
E represents the kinetic energy (J) required for the conveyance,
m represents the mass (kg) of the material, and
v represents the conveyance speed (m/s).

In addition, in the case where there is a height difference between positions where the part is held in the course of the part conveyance, the calculation precision of the energy net may be improved by taking not only the kinetic energy but also the potential energy into consideration among the mechanical energy. Alternatively, for a unit classified into the electronic device use, the energy net can be obtained from the electric energy. For a unit classified into the light source use, the energy net may be obtained from a theoretical formula of an optical energy.

Meanwhile, the energy required for the weight measurement of a part, which is an operation by the weight measurement motor, does not give an added value and is not classified as the energy net, but is an operation necessary for molding the material and is therefore neither classified as the energy waste. Therefore, the entirety of the energy consumption amount measured in the weight measurement motor as a unit can be classified as the “energy incident” without performing calculation based on theoretical calculation. As described above, in the classification according to the present embodiment, the energy consumption content may be classified in accordance with the type of operation performed by the unit, and the classification items may be accumulated in the consumption content DB 211.

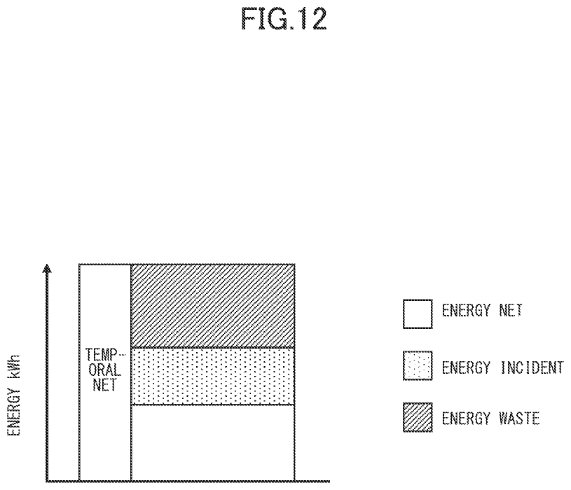

FIG. 12 is an example of visualization of the classification results for each unit and consumption content, and can be displayed on the display portion 4 of FIG. 1. In FIG. 12, the energy of the temporal net classified and displayed in the visualization mode for each piece of equipment and operation content, which is a visualization mode of the previous stage, is further classified into the energy waste, the energy incident, and the energy net in the visualization mode for each unit and consumption content. The user can analyze the waste of the energy more appropriately, and can set the priority order to reduce the waste, on the basis of the classification results visualized by the information processing apparatus.

For example, regarding the energy of heat radiation classified as the energy waste derived from the operation of the cylinder heater in the exemplified units, thermal insulation of the cylinder can be considered as a reduction measure. By thermally insulating the cylinder by, for example, installing a thermally insulating cover, the user can reduce the waste with a relatively higher cost effectiveness in the temporal net. That is, by changing the perspective regarding the classification, it can be seen that “energy waste” hides in the temporal net obtained by the classification in accordance with the operation content. According to the information processing apparatus of the present embodiment, these can be classified and visualized stepwise and hierarchically, the user can extract the waste of the energy appropriately and finely, and thus can find the reduction measure.

In addition, regarding the energy classified as the energy incident derived from discharge in FIG. 6, altering the discharge unit to improve the energy efficiency from the current state can be considered as the reduction measure. However, since alteration takes more time and cost than installing the thermally insulating cover on the cylinder heater as described above, the user can determine that positioning this in the second place in the priority order and executing this stepwise is desirable in terms of cost efficiency.

For another example, the energy for material melting classified and visualized as the energy net is energy necessary for giving an added value to the material, and therefore the user can determine that this energy is placed low in the priority order for reduction. On the other hand, reduction of the energy net is not impossible, and it can be said that even the energy net can be reduced by changing the material to one that melts at a lower temperature. However, if the material is changed, the material characteristics of the molded part produced by the molding machine also changes, and therefore it is necessary to change the material in accordance with the result of the functional inspection and the quality assurance inspection of the final product in which the molded part is incorporated. Therefore, by executing this with a lower priority, the overall cost efficiency of the energy consumption reduction activity performed on the molding machine can be maximized.

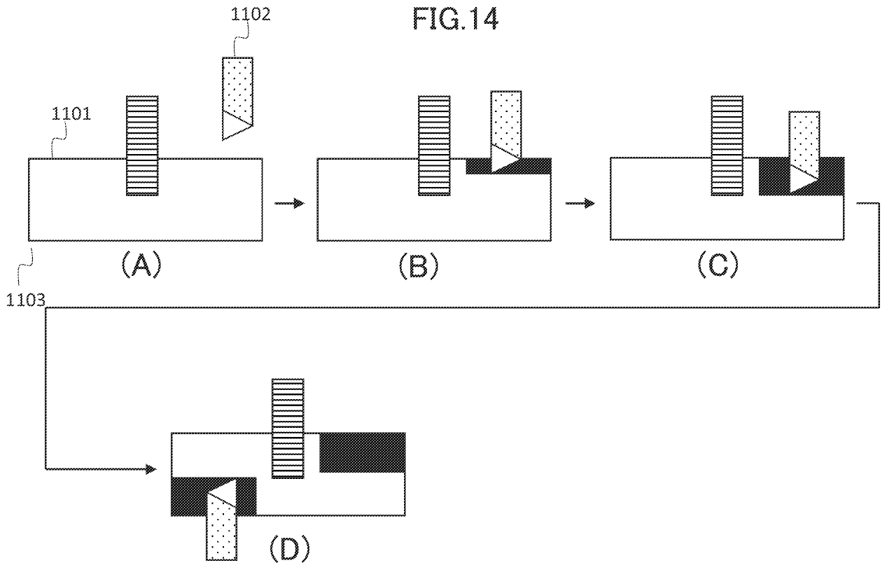

As another example, a case of a cutting processing machine will be described. During the orientation inversion described with reference to FIG. 13, the energy used for driving the stage to move the material to a position where manual work can be performed is classified as the energy incident. To reduce this energy, for example, configuring the apparatus such that the cutting tool can come into contact with the material from the back side of the stage can be also considered. As illustrated in FIG. 14, the shape of the material gripping portion provided in the cutting processing machine may be configured to grip a part of the material that is not removed. In addition, the energy consumed by idling of the cutting tool during the orientation inversion is classified as the energy incident. If the material holding portion is configured such that the cutting tool can come into contact with the material from the back side, the orientation inversion operation becomes unnecessary, and therefore this energy is also reduced. Alternatively, in the case of a part of a complicated shape in which a material gripping shape that eliminates the necessity of the orientation inversion operation cannot be formed, the stage has to be used as illustrated in FIG. 13. However, if the motor is replaced by one that can stably operate even when the rotation of the cutting tool is stopped during the orientation inversion operation and the rotational speed of the cutting tool is quickly increased to a desired speed by reactivating the motor after finishing the inversion operation, the energy classified as the energy incident can be reduced. If this measure is applied to the energy incident consumed by the idling in a period between the steps (A) and (B) where the cutting tool idles until coming into contact with the material, the consumed energy can be reduced by similarly shortening the idling time.

By widely applying this idea to equipment other than the molding machine, workplaces other than the molding workplaces, and further other buildings, a priority order can be set for the reduction measure of the entirety of a large-scale production factory. Although it is theoretically not impossible to simultaneously execute all the energy consumption reduction measures that can be conceived, this requires a lot of workforce and investment. If the consumed energy of the facility can be reduced, the effect in terms of reduction of an environmental load is high. However, the cost down effect obtained by this is not necessarily high although this depends on the unit price of the power. In view of this, it is effective to reveal the cost efficiency by the classification processing such that the reduction measures can be executed in consideration of the priority order. In addition, since the production factory plays a role of producing a large amount of products quicker and at a lower cost, there is a case where a large-scale investment cannot be easily performed for the sole purpose of reducing the energy consumption. In view of such characteristics of production factories, the user can set the priority order that is industrially useful by the classification processing executed by the information processing apparatus of the present embodiment.

In the information processing apparatus of the present embodiment, in the selection of the visualization mode in step S3 of FIG. 7, at least three kinds of visualization modes including a visualization mode for each workplace and use, a visualization mode for each piece of equipment and operation content, and a visualization mode for each unit and consumption content can be received. Although an embodiment in which these are sequentially executed in series has been described, only one of the modes described above may be executed. Alternatively, the information processing apparatus may separately execute a plurality of modes in parallel. In the example described above, the visualization mode for each unit and consumption content is only applied to the energy of the temporal net screened through the visualization mode of the first stage on the basis of the execution results of the visualization mode for each piece of equipment and operation content. In contrast, the visualization mode for each unit and consumption content may be executed in parallel for all of the temporal waste, the temporal incident, and the temporal net that are the results of the visualization mode for each piece of equipment and operation content instead of executing the visualization modes in series. In this case, the temporal incident can be further classified into the energy waste, the energy incident, and the energy net on the basis of the energy consumption content derived from the operation of each unit. As a result of this, the user can extract the waste of the energy more appropriately and more finely, and thus execute the reduction measures.

In addition, what is executed by the information processing apparatus of the present embodiment is not limited to the three kinds of visualization modes described above. For example, one visualization mode may be selected for a range classified into two or more items in the item group of Gr. 2, the item group of Gr. 3, and the item group of Gr. 4 in FIG. 1. In addition, the execution is not limited in any way, and the execution order may be reversed, or the execution may be performed in series or in parallel.

For example, all the energy consumed by the facility may be classified on the basis of the uses in the use DB 208 and on the basis of the operation content DB 210. For example, as an air conditioning use, there is a case where a turbo freezer that supplies cold water to the whole facility is concentratively managed. Therefore, the waste of energy may be classified in association with the added value on the basis of the details of the operation content of each time period as concentratively managed equipment as illustrated in FIG. 5. In this case, the user can easily conceive a measure including the entirety such as turning the power of the turbo freezer off during planned stop of the entire facility.

Alternatively, if a workplace where the air conditioning load is locally large due to a reason such as concentration of pieces of equipment that generate heat is found from the visualization mode for each workplace and use as a result of the information processing apparatus classifying the air conditioning system for each workplace, the user can install a package air conditioner that locally acts on that workplace. As a result of this, the entire facility can be maintained at a comfortable temperature without fully driving the large turbo freezer to the limit of the rated power, and thus energy consumption reduction of high cost efficiency can be executed.

Alternatively, as a result of the information processing apparatus visualizing the classification processing by one of the visualization modes described above, a measure conceived by the user may be laterally and commonly applied to buildings, workplaces, equipment, and units attributed to the same use. For example, in the case where a piece of equipment in charge of the melting step in the thermal use is also in a workplace other than the molding workplace of FIG. 2, that is, in the reflow furnace of the electric component installation workplace or the electric furnace of the fixing belt workplace, the heat radiation measure that is a reduction measure for the same thermal use can be applied.

Therefore, if the reduction measure conceived by the user is recorded in an unillustrated database provided in the information processing apparatus of the embodiment in association with the type of the use, workplace, equipment, unit, and added value, the reduction measure can be applied laterally to the uses, workplaces, equipment, and units. In addition, if reduction measures are accumulated in the database in association with the uses, workplaces, equipment, and units and a recommendation display portion that displays a reduction measure associated with a specific use on a display portion as recommendation when the specific use is selected by the user is further provided, the reduction measure can be laterally applied easily.

As described above, the information processing apparatus according to the embodiment receives and stores setting of a plurality of kinds of classification items for classifying the power consumption in a facility. Information (for example, measurement data) about the power consumed in the facility is classified on the basis of two or more classification items selected by the user. The plurality of kinds of classification items are each hierarchically configured, and the following examples can be included.

First, the plurality of kinds of items can include a power system (for example, substations, switchboards, distribution boards, and the like) that is hierarchically configured. Further, the plurality of kinds of the items can include items (for example, buildings, workplaces, equipment, units constituting the equipment, and the like) hierarchically classified on the basis of the operation system of the facility whose configuration does not necessarily match the power system.

In addition, the plurality of kinds of items can include items (for example, thermal use, driving use, air use, vacuum use, and the like) of uses of energy that are laterally applied to one or more hierarchies in the facility and distinguished in accordance with the content of energy consumption in the corresponding hierarchy.

In addition, the plurality of kinds of items includes items (for example, the net, the incident, and the waste) of added value that are laterally applied to one or more hierarchies in the facility and created in accordance with the content of operation or the content of energy consumption in the corresponding hierarchy. The items of the added value may be distinguished as references for the priority order of the energy consumption reduction. For example, in the case of analyzing the power consumption related to production or processing of a product, the “net” as a classification item of the added value is set in correspondence with the operation content or time that is necessary and directly contributes to the production or processing. Since the “net” is associated with power consumption that is necessary or close to necessary, the “net” is treated in a lower place than the “waste” and the “incident” in the priority order for considering energy consumption reduction.

The information processing apparatus of the embodiment receives and stores a combination of classification items selected by the user from a plurality of kinds of hierarchical classification items. Then, information (for example, measurement data) about the power consumed by the facility or the like is obtained, and classification is performed on the basis of the combination of the selected classification items. At the time of the classification, the consumed power may be distributed to each classification item in accordance with a preset distribution ratio.

The information processing apparatus can store classification results, and can display information about the classification result on a display portion. For example, the classification results can be displayed on the display portion as a graph associated with the classification items so as to be easily understandable for the user. The information processing apparatus may display the priority order according to the items (for example, the net, the incident, the waste, and the like) of the added value such that the user is guided when considering the energy consumption reduction.

The information processing apparatus can transmit information about the classification results to an external apparatus (for example, an external computer or database) via a network, causing a storage medium to store the information, or causing a printing apparatus to print the information.

According to the information processing apparatus of the embodiment, the total consumption amount of the consumed energy of a large-scale facility that consumes power can be comprehensively grasped, and the waste can be visualized in association with the buildings, workplaces, equipment, units, and the like that do not necessarily match the physical power system. For example, by visualizing the order of the value of the consumption amount, the user can be assisted for considering a reduction measure of a high cost efficiency for the buildings, workplaces, equipment, units, and the like. For example, the user can laterally apply the reduction measure to the buildings, workplaces, equipment, and units attributed to the same use of energy, and thus can efficiently execute an energy consumption reduction activity in a large scale.

### Second Embodiment

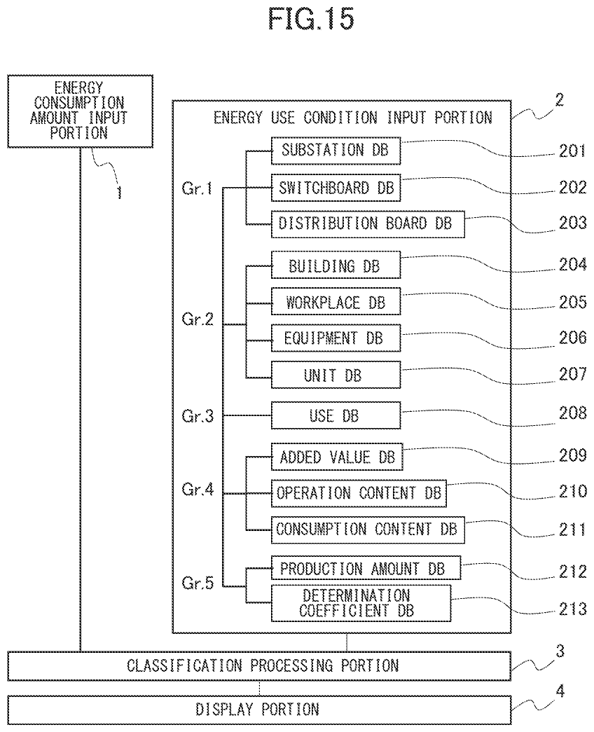

FIG. 15 is a schematic diagram illustrating an example of a configuration of an information processing apparatus according to a second embodiment. In the second embodiment, a production amount DB 212 and a determination coefficient DB 213 are provided in addition to the configuration illustrated in FIG. 1 in the first embodiment. The production amount DB 212 and the determination coefficient DB 213 belong to Gr. 5 in the classification group information.

The production amount DB 212 is a database in which information about the production amount of produced products or parts constituting the products in the building DB 204, the workplace DB 205, the equipment DB 206, the unit DB 207, and the like of the classification group Gr. 2 is recorded. The production amount DB 212 records the names of the products or parts, the production amounts corresponding to the products or parts, and the times when the products or parts are produced in association with each other. As described above, the classification processing portion 3 associates the classification items of the classification group Gr. 2 and the classification items of the classification group Gr. 5 with each other such that, for example, how many and what kind of products or parts are produced in a time period of when to when can be grasped for each workplace in the workplace DB 205. The names of the products or parts recorded in the production amount DB 212 may be names such as “Model A” and “Molded Part A-1”, or may be signs such as part numbers like “1125” in a predetermined format for identifying the name.

The classification processing portion 3 associates the electric energy input to the energy consumption amount input portion 1 with the classification items of the classification group Gr. 2 and the classification items of the classification Gr. 5, and calculates the energy intensity by the formula (3) below.

(energy intensity)=(electric energy)/(production amount) (3)

In the formula (3), as the electric energy serving as the numerator on the right side, a value calculated in advance by the classification processing portion 3 for each element that consumes power such as a workplace or equipment by using the association information similarly to the first embodiment is input. The production amount serving as the denominator on the right side in the formula (3) is calculated by the classification processing portion 3 for each element that consumes power such as a workplace or equipment similarly to the calculation of the numerator by using the association information of the second embodiment. The energy intensity on the left side obtained by the formula (3) is energy used for producing one product or one part.

As a result of the classification processing portion 3 displaying the result of dividing the electric energy by the production amount on the display portion 4, the user can notice that there is a possibility that the power is consumed inefficiently. For example, when the energy consumption amount is compared between the yesterday's production and the today's production, there is a case where the today's energy consumption amount is 90% of the yesterday's and apparently the energy consumption amount is reduced by 10%. However, there is a case where the production amount is reduced to 80% of the yesterday's, and thus the energy consumption amount per product is larger than the yesterday's. Specifically, there can be a case where the electric energy used for the yesterday's production is 100 kWh and the production amount is 10 products, and the electric energy used for the today's production is 90 kWh and the production amount is 8 products. At this time, whereas the yesterday's energy intensity is 100 kWh/10 products=10 kWh, the today's energy intensity is 90 kWh/8 products=11.25 kWh. Although the energy consumption amount appears to be reduced if just the electric energy serving as the numerator, that is, just the “amount” of consumption is looked at, it can be seen that the energy used for production per product is increased by grasping the energy intensity.

As described above, when the display portion 4 displays the calculated energy intensity, the user can recognize the possibility that the energy is consumed inefficiently, and thus can execute the visualization mode for each piece of equipment and operation content described in the first embodiment. The classification processing portion 3 performs classification by associating the operation content with the energy use amount in time series as illustrated in FIG. 10A by the association between the equipment DB 206 and the added value DB 209, and displays the classification results on the display portion 4. At this time, the cause of the waste that the energy consumption amount during planned stop has increased as a result of the time of the planned stop being longer than yesterday due to decrease of the production amount to 80% from yesterday can be analyzed from the graph of the display portion 4. In the second embodiment, a situation in which the amount of waste per product has increased even though the usage amount has decreased as compared with a period to be compared with can be visualized, and the cause thereof can be analyzed. Further, the classification items of the classification group Gr. 2 and the classification items of the classification group Gr. 5 are associated. Therefore, arbitrary elements that consume power can be selected from the classification items constituting the classification group Gr. 2 such as buildings, workplaces, equipment, and units, and thus the energy intensity for the selected elements can be grasped.

To be noted, for some workplaces, there is a case where employing a part weight (kg), a processing time (minute), or the like as the denominator of the formula for calculating the energy intensity instead of the number of products or parts is appropriate, and in this case, arbitrary units such as weight and processing time may be set as the units of the production amount DB 212 in association with each workplace of the workplace DB 205. In addition, since the unit of the denominator of the energy intensity differs for each workplace, there is a case where it is difficult to calculate the energy intensity collectively for a building. For example, there is a case where the energy intensities cannot be simply summed up such as a case where the denominator is the number of products in the assembly workplace and the denominator is the weight (kg) of the parts in the molding workplace. In such a case, a common index proportional to the production amount such as the sales of the products or parts may be employed as the denominator. As described above, by uniformizing the unit of the denominator of the energy intensity for a plurality of classification items, the energy intensity can be calculated for an arbitrary hierarchy.

In addition, since the production amount DB 212 records information about the part number, the energy consumption amount corresponding to the numerator of the energy intensity can be displayed for each part number in a cumulative bar chart. At this time, by associating the workplace DB 205 and the production amount DB 212 with each other, the energy consumption amount of each part number in the workplace may be displayed in a cumulative bar chart. Alternatively, the energy consumption amount of each of a plurality of part numbers may be plotted for a specific time period in a time-series line graph whose horizontal axis represents the time for comparison. Two different time periods may be selected, and the energy consumption amounts of the two time periods may be compared in a line graph for a specific part number.

Alternatively, by inputting planned values of the energy consumption to the energy consumption amount input portion 1 instead of the actual values of energy consumption in the past, the plan and the reality may be compared for each part number. In addition, by associating the energy consumption amount input portion 1 with the classification group Gr. 2, the planned values can be displayed on the display portion 4 for each hierarchy such as the buildings, workplaces, equipment, or the like. Further, the display can be performed by the classification processing portion 3 switching between displaying the planned values of the energy consumption amount and displaying the planned values of the energy intensity.

In the second embodiment, the classification processing portion 3 calculates a standard value of the energy intensity by using a value in the determination coefficient DB 213, and by comparing the standard value of the energy intensity with the actual value of the energy intensity, and a notification may be made to the user in the case where the actual value exceeds the standard value. This processing will be described below.

The determination coefficient DB 213 records values for adjusting the standard value for the energy intensity when setting the standard value, which is a value for determining which value is in the normal energy usage status and which value is in the abnormal energy usage status. Here, the normal usage is reasonable usage in terms of usage of energy required for production. The abnormal usage means that the energy is abnormally greatly used due to an inappropriate production condition or the like such a case where, for example, the temperature setting of the injection molding machine is abnormally higher than a predetermined value and thus the energy usage amount is abnormally larger than the normal case. Alternatively, a situation in which defective products are frequently produced and thus the energy consumption per good (complete) product is remarkably larger than the normal is also determined as abnormal in the second embodiment.

The classification processing portion 3 calculates the standard value for the energy intensity as expressed by the formula (4).

(standard value for energy intensity)=(electric energy)/(production amount)×(determination coefficient) (4)

The determination coefficient can be set for an arbitrary hierarchy by the classification processing portion 3 associating the determination coefficient DB 213 of the classification group Gr. 5 with the classification items of the classification group Gr. 2. For example, the determination coefficient can be set for each workplace by associating the determination coefficient DB 213 with the workplace DB 205, and may be set for each piece of equipment by associating the determination coefficient DB 213 with the equipment DB 206. Alternatively, by associating the determination coefficient DB 213 and the production amount DB 212 of the classification group Gr. 5 with the classification items of the classification group Gr. 2, the determination coefficient may be set for each part number and each model name of the product.

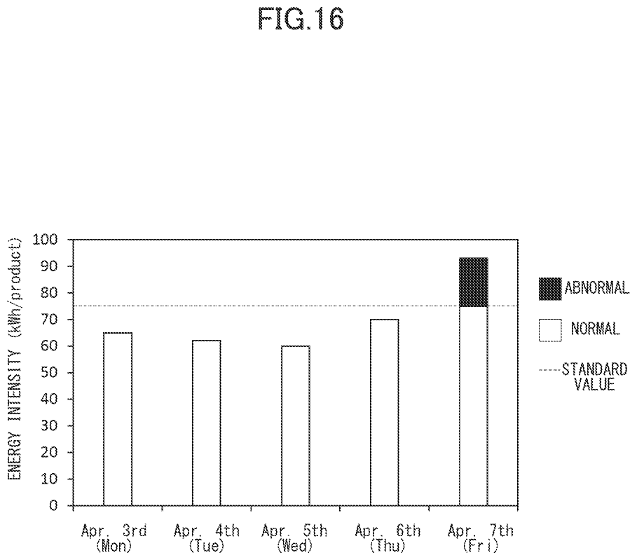

FIG. 16 illustrates the daily energy intensity per part in the molding workplace. In the example of FIG. 16, the standard value is 75 kWh, and a line indicating 75 kWh extending from April 3rd (Mon) to April 7th (Fri) is illustrated. Part of the energy intensity exceeding the standard value is illustrated in black as an abnormal value, and part of the energy intensity not exceeding the standard value is illustrated in white as a normal value.

The classification processing portion 3 extracts the electric energy of an arbitrary hierarchy in an arbitrary time period by using the association between the energy consumption amount input portion 1 and the classification group Gr. 2. Then, the classification processing portion 3 extracts the production amount of that time period and that hierarchy from the production amount DB 212 on the basis of the association, and divides the electric energy by the production amount. The classification processing portion 3 multiplies the quotient by a determination coefficient, and a case where the determination coefficient is 1 will be considered. In this case, an actual value of the energy intensity of the arbitrary time period is employed as the standard value. For example, the energy intensity of one month from March 1st (Wed) to March 31 st (Fri) as the arbitrary time period may be employed, the sum of the energy usage amount of that one month may be calculated as the electric energy for the numerator, and the sum of the part production amount of the molding workplace of that one month may be calculated as the production amount for the denominator.

The classification processing portion 3 compares the actual value and the standard value of the energy intensity, and when the actual value exceeds the standard value, the portion of the energy intensity exceeding the standard value is notified to the user by being displayed in a different color as exemplified in FIG. 16. The notification may be performed by displaying a graph as in FIG. 16, or a method such as notification via an e-mail in addition to displaying the graph or notification via a smartphone or a smartwatch may be employed. In this manner, the information processing apparatus of the second embodiment can quickly detect and notify to the user a workplace that is consuming an abnormally large energy on the basis of the standard value of the energy intensity. In addition, since the classification group Gr. 2 and the classification group Gr. 5 are associated as in the configuration of FIG. 15, the abnormality can be notified for an arbitrary hierarchy such as a building, a workplace, equipment, or a unit.

Further, since the classification group Gr. 5 also records information of the model names and part numbers, the abnormality or normality can be also determined for each model and part number. In addition, although the energy intensity is calculated and displayed for each day in FIG. 16, the electric energy of one week may be divided by the production amount of one week, the electric energy of one hour may be divided by the production amount of one hour, and the energy intensity of an arbitrary time period can be calculated and displayed. At this time, since the unit of the energy intensity is kWh/product, the value of the energy intensity of the standard value is fixed as energy per product or part even if the granularity of the horizontal axis of the graph of FIG. 16 is any granularity such as one hour, one day, or one week. Therefore, the standard value and the determination results do not increase or decrease when the displayed time period and granularity are changed, and the standard of the determination regarding abnormality and normality displayed on the display portion 4 can be maintained at a certain height unless the user changes the determination coefficient.

Since time-series data is input to the energy consumption amount input portion 1 every moment, the classification processing portion 3 performs the determination in real time with respect to the production activity, the user can be quickly notified of abnormal consumption. The user can quickly start reconsidering the apparatus settings in response to this notification. Alternatively, also in the case where the consumed electric energy is reduced to 90% of the yesterday's but the energy intensity has increased because the production amount is reduced to 80% of the yesterday's, the classification processing portion 3 can notify the user that the energy intensity is an abnormal value.

To be noted, although the determination coefficient may be 1, the determination coefficient may be set to a smaller value such as 0.8 to be stricter on the basis of the reduction goal of the workplace such that the standard value becomes smaller. If the standard value is set to be smaller, the frequency of determination as an abnormal value by the classification processing portion 3 increases. Therefore, the determination coefficient can be considered as a value for adjusting the sensitivity for detecting abnormality.

Whereas the consumption amount of the waste is quantitatively visualized on the basis of the priority order of the energy usage amount in the first embodiment, the second embodiment is characterized in that notification indicating that wasteful consumption is occurring is quickly issued. Therefore, the first embodiment and the second embodiment can be combined to quickly detect a situation in which wasteful consumption is occurring and then classify and display the amount of the waste. Alternatively, if the user can visually recognize that the temperature setting of the molding machine is abnormal on the basis of the notification, a measure can be executed first by skipping the step of extracting the amount of waste, and thus the reduction measure can be executed immediately. Then, the effect of the reduction measure can be examined by executing the visualization mode for each piece of equipment and operation content of the first embodiment and comparing the energy usage amount and the wasteful consumption amount between before and after the measure.

Although a method of determining a normal state or an abnormal state by calculating the standard value for the energy intensity has been described above, a production facility does not necessarily continuously operate for 24 hours every day, and in this case, it is possible that the production amount data for the denominator of the energy intensity does not exist. In the present embodiment, a time in which the production is performed is defined as the operation time, and a time in which the production is not performed is defined as the non-operation time. A method of determining the normal state and the abnormal state in the non-operation time will be described below.

In the non-operation time, the classification processing portion 3 obtains the power (kW) of the equipment in a certain period in the non-operation time, and employs this power value as the power of the normal state.

Then, the classification processing portion 3 obtains the determination coefficient from the determination coefficient DB 213 and calculates the standard value of the power in the non-operation time by the formula (5).

(standard value of power in the non-operation time)=(power in the normal state of the non-operation time)×(determination coefficient) (5)

Here, the unit of the power is kW or W, and is distinguished for use from kWh or Wh that are units of electric energy. The power in the normal state of the non-operation time can be set for an arbitrary hierarchy such as a building, workplace, equipment, or unit by the classification processing portion 3 associating the energy consumption amount input portion 1 with the classification group Gr. 5. Similarly to the standard value in the operation time, the classification processing portion 3 can set the determination coefficient for an arbitrary hierarchy by associating the determination coefficient DB 213 of the classification group Gr. 5 with the classification items of the classification group Gr. 2.

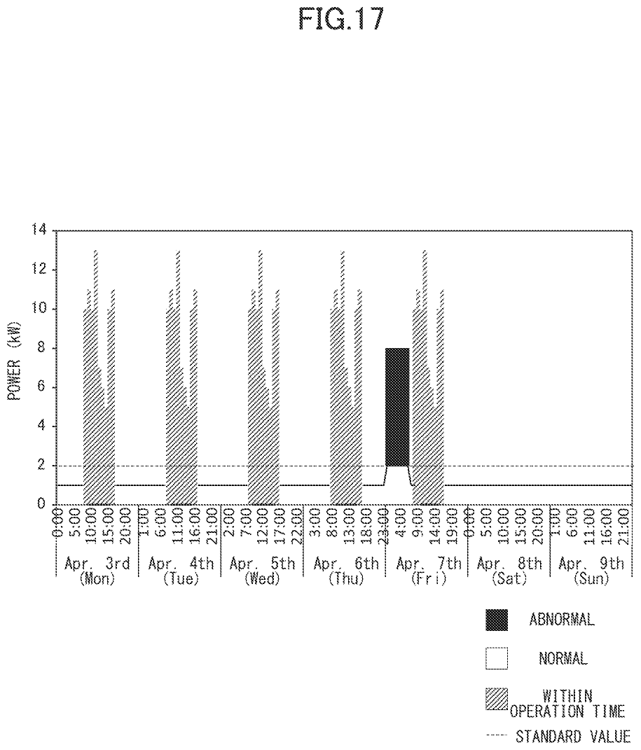

FIG. 17 illustrates an example of results of determining whether the energy usage status of the molding workplace is normal or abnormal by comparing the standard value with the actual value of the equipment in the non-operation time by the classification processing portion 3. Since the region indicated by a texture of diagonal lines is power in the operation time, and therefore is not a target of determination of the formula (5). In FIG. 17, 0:00 to 8:00 on April 3rd is the non-operation time, the power in this time period is 1 kW, and the standard value is 2 kW, and therefore the classification processing portion 3 determines that the normal state is taken. In contrast, 0:00 to 7:00 on April 7th is the non-operation time, the power in this time period is 8 kW, and the standard value is 2 kW, and therefore the classification processing portion 3 determines that the abnormal state is taken. This abnormal state indicates that the equipment is consuming abnormally large power due to some cause even though the equipment is in the non-operation time, that is, even though the equipment is not performing production. In this manner, the classification processing portion 3 can quickly detect a state in which power is abnormally consumed in the non-operation time as compared with the normal state, and can notify the user of this state.

At this time, the classification processing portion 3 may set the standard value for determination to be stricter by setting the determination coefficient of the formula (5) to be smaller, and thus the abnormality may be determined more sensitively. In addition, the power in the normal state in the non-operation time employed in the description above may be updated in a certain time period different from the time period employed when calculating the standard value in the past, for example, when replacing a piece of equipment with a new one. The value employed by the classification processing portion 3 as the power of the normal state varies depending on the piece of equipment, and for example, there is a case where the standard value is 0 kW such as a case of an assembly robot because the equipment stops completely in the non-operation time. In addition, there is a case where the standard value is not 0 kW and a state in which power is stably consumed is a normal state such as a case of a server or exhaustion equipment. Further, since the classification group Gr. 5 is also associated with Gr. 1, the determination on normality or abnormality may be executed by setting the standard value for power data of each distribution board instead of performing determination on power data of each piece of equipment.

### Third Embodiment

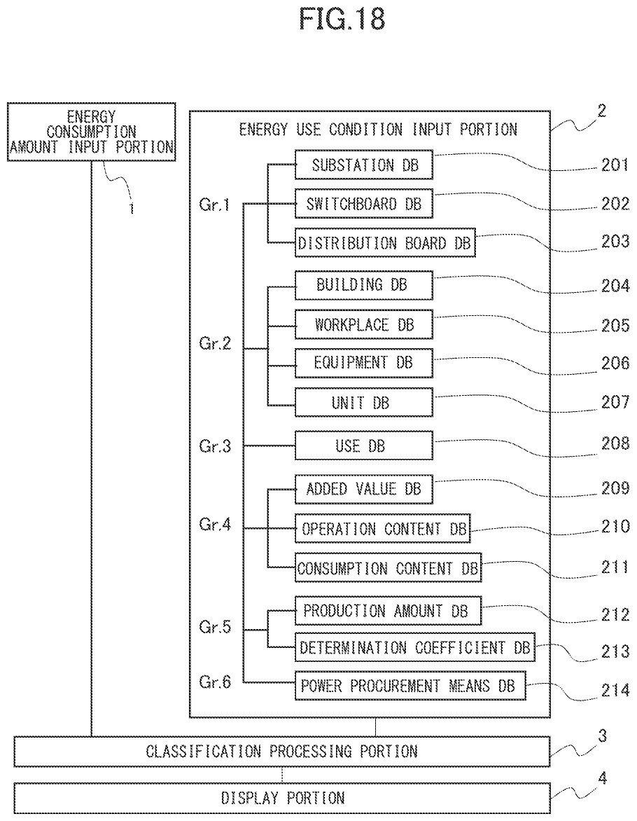

In a third embodiment, an example in which the visualization of the introduction status of renewable energy in a facility that consumes power by providing the information processing apparatus with a database recording information about the usage status of the renewable energy will be described. FIG. 18 is a schematic block diagram illustrating an example of a configuration of an information processing apparatus according to the third embodiment. In the third embodiment, a power procurement means DB 214 is provided in addition to the configuration of the second embodiment illustrated in FIG. 15. The power procurement means DB 214 is attributed to Gr. 6 in the classification group information.

The power procurement means DB 214 is a database in which renewable energy procurement means in a facility that consumes power such as a production factory is recorded. The renewable energy is energy in the nature that does not discharge a greenhouse gas, and examples of a power generation source of the renewable energy include solar light, wind power, water power, terrestrial heat, and biomass. The power procurement means DB 214 records information about which means the facility uses to procure the renewable energy, regardless of the kind of the power generation source.

Examples of the procurement means include procuring a menu of renewable energy from a retail power business operator, purchasing a certificate for renewable energy, generate power domestically, and power purchase agreement (PPA). Procuring a menu of renewable energy from a retail power business operator means selecting and procuring a menu from menus of renewable energy sold by a retail power business operator similarly to purchase of power generated by using a normal fossil fuel as an energy source. For example, there can be options such as purchasing a menu 100% of which is renewable energy, and purchasing a power menu constituted by 50% of renewable energy and 50% of thermal power generation. Purchasing a certificate means, by purchasing a certificate such as a non-fossil fuel certificate, a green power certificate, or a J credit from a certificate issuing business operator, gaining public certification regarding that a portion of the power consumption of the facility corresponding to the purchased certificate is generated from renewable energy. Generating power domestically means generating and consuming power within the own facility by the business owner of the facility building power generation equipment for renewable energy in the facility. Examples of the procurement means corresponding to the domestic power generation include installing a solar panel on the rooftop of a factory and installing a wind power engine in the site. Power purchase agreement (PPA) means purchasing power obtained from power generation equipment for renewable energy in a long-term contract, and is also referred to as a power purchase contract. The PPA can be, for example, an on-site PPA in which a power generation source for renewable energy such as a solar panel is installed in the site of the purchaser in a long-term contract with a lease company and using the power generated thereby. Alternatively, the PPA can be an off-site PPA in which power generated by a solar panel installed in an area out of the site by the lease company is procured through a public power supply line.

The power procurement means DB 214 records information indicating how much of electric energy is procured by which means among a plurality of kinds of procurement means and used in the facility. The classification processing portion 3 can grasp the situation regarding the procurement status as to, for example, how much of electric energy in which building is procured from the renewable energy of which procurement means, by associating the classification group Gr. 2 and the classification group Gr. 6 with each other. Regarding the information of the building recorded in the building DB 204 of the classification group Gr. 2, the names of buildings may be recorded for a plurality of facilities.

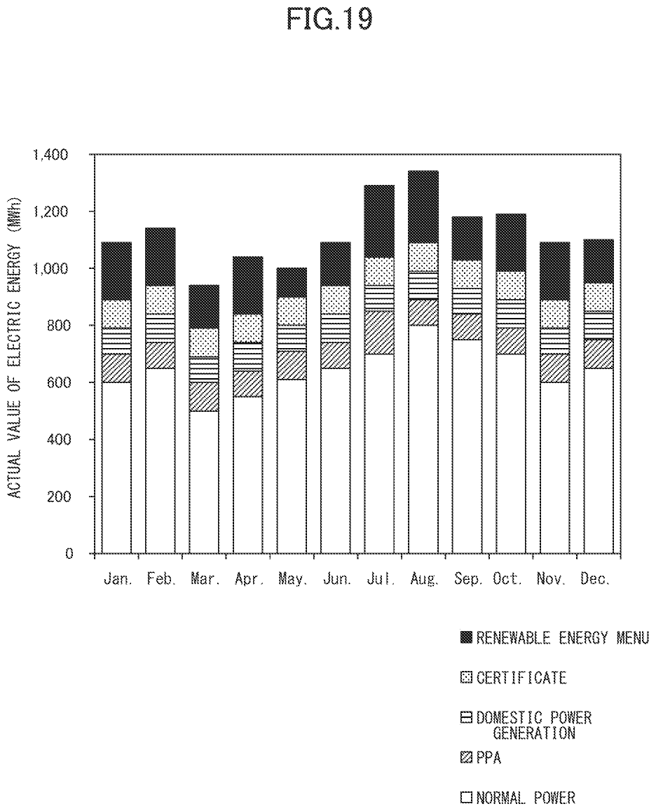

FIG. 19 illustrates an example in which the classification processing portion 3 has executed the classification processing in the third embodiment and the introduction status of the renewable energy in a facility serving as a visualization target is displayed on the display portion 4. In FIG. 19, the monthly actual value of the electric power procured in the facility is displayed. FIG. 19 illustrates a cumulative bar chart in which a plurality of kinds of different procurement means are distinguished by textures such as diagonal lines and horizontal lines and stacked in the vertical axis direction. “RENEWABLE ENERGY MENU” indicates the amount by which a menu of renewable energy is procured from a retail power business operator. “CERTIFICATE” indicates the amount procured by purchasing a certificate. “PPA” indicates the amount procured by power purchase agreement. “NORMAL POWER” indicates the amount procured from a power generation source using a source different from renewable energy such as a fossil fuel.

In this manner, information indicating how much of renewable energy is introduced into a certain facility can be comprehensively grasped. The unit of the vertical axis is an actual value of the electric energy (MWh), and the procurement amount is equal to the actual value of the usage amount. Alternatively, the vertical axis may be converted into a proportion (%), and the proportion of the electric energy of each procurement means may be displayed. Alternatively, the unit price of power of each procurement means can be recorded in association with the procurement means in the power procurement means DB 214. In this manner, by multiplying the actual value of the electric energy by the unit power price of each procurement means, the price of the procurement cost of each procurement means can be displayed. Since the unit power price can be different depending on the procurement means, the display may be switched between display of the electric energy and display of the procurement cost, or these two kinds of graphs may be simultaneously displayed side by side for comparison.

The procurement amount of one facility is displayed in FIG. 19. However, in the case where a certain company owns a plurality of facilities, information about buildings of the plurality of facilities is recorded in the building DB 204 of the classification group Gr. 2, and this information is associated with the information of the power procurement means DB 214 of the classification group Gr. 6. As a result of this, the sum of the power procurement amounts in a plurality of facilities can be displayed. Alternatively, the usage amount of each facility may be displayed side by side. The facility of a company is also referred to as a business facility, and the introduction status of renewable energy can be compared between business facilities. Alternatively, an introduction status that, in a specific facility, an A building is provided with a solar panel and generates power domestically, but a B building is not yet provided with a solar panel can be grasped.

In the case of consuming power obtained from a renewable energy source, since the amount of carbon dioxide discharge is reduced, if renewable energy is already introduced into a large part of equipment in a building, generation of a greenhouse gas caused by power consumption is suppressed to a certain degree in that building. Therefore, if equipment installed in that building runs on renewable energy, the necessity of performing an activity to reduce the power consumption amount from the viewpoint of environmental load can be low. Therefore, on the basis of the display results of the third embodiment, a determination to execute the reduction measure with a higher priority on a building that consumes power of a power generation means that uses a lot of fossil fuel can be made.

Alternatively, the introduction status of renewable energy may be visualized for each workplace by using the information recorded in the workplace DB 205 of the classification group Gr. 2. In the workplace DB 205, a wider variety of units of workplace such as departments, divisions, and business headquarters constituting the workplace may be recorded in addition to workplaces in a specific facility, and thus the hierarchy of the organization may be systematically managed. Further, in this case, if the classification processing portion 3 associates the workplace DB 205 with the power procurement means DB 214, the introduction status of the renewable energy can be visualized for each organization in various hierarchies such as workplaces, departments, divisions and business headquarters constituting a company. In addition, the usage status of power derived from a fossil fuel, which is not renewable energy, can be visualized for each of the organizations.

In the third embodiment, the classification processing portion 3 can perform classification and display by using the procurement amount and procurement cost of each power procurement means, and it is also possible to simulate the procurement cost by predicting the future procurement amount of each procurement means. To realize this, a predicted amount of energy usage that will be required in the future may be input to the energy consumption amount input portion 1 by the user in advance in addition to the actual values. Next, the classification processing portion 3 associates the classification group Gr. 2 with the power procurement means DB 214 of the classification group Gr. 6. As a result of this, the classification processing portion 3 can simulate the required procurement cost for each procurement means on the basis of the predicted amount of the energy usage and unit price of an arbitrary hierarchy such as a building or workplace.

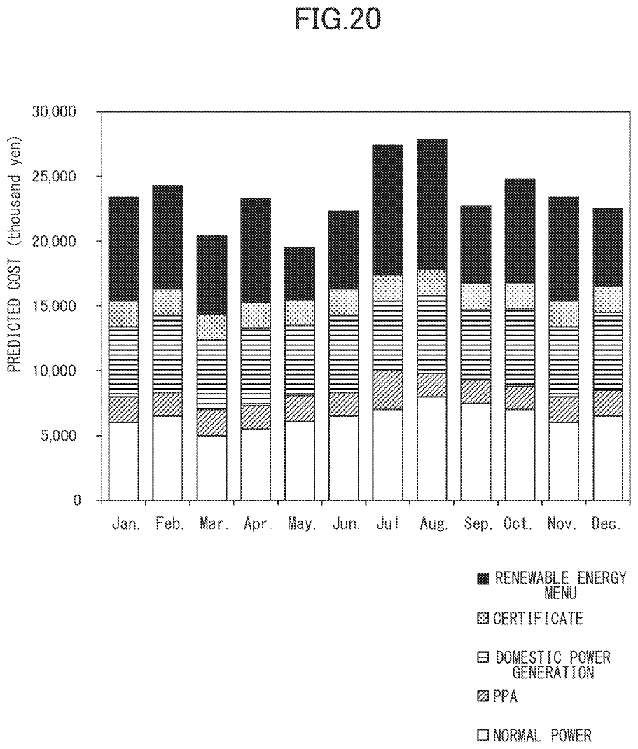

FIG. 20 illustrates an example of simulation of the predicted cost for each procurement means performed on the basis of the electric energy required by the target facility illustrated in FIG. 19. In FIG. 20, a predicted cost of a case where the normal power derived from a fossil fuel and the like is procured less than in FIG. 19 and more power is procured from the menu of renewable energy and domestic power generation than before.

As a result of this display, the cost required in the case where the renewable energy is increased or decreased in the future can be grasped for an arbitrary hierarchy such as a building or a workplace with reference to the actual values of energy usage in the past. In addition, by inputting the planned values of the production amount to the production amount DB 212 of the classification group Gr. 5 and associating the classification group Gr. 2 with the classification group Gr. 5 by the classification processing portion 3, and thus a predicted value of energy usage amount of an arbitrary hierarchy may be calculated. In this manner, the prediction value of the energy usage amount can be calculated by the classification processing portion 3 on the basis of the production plan, and the predicted cost for each procurement means can be further calculated and displayed on the display portion 4 on the basis of the predicted value.

### Modifications of Embodiments

To be noted, the present invention is not limited to the embodiments and examples described above, and can be modified in many ways within the technical concept of the present invention. For example, all or part of the different embodiments described above may be combined for implementation. Embodiments of the present invention also include a program that causes a computer to execute the information processing described above and a computer-readable recording medium storing this program.

The information processing method and the information processing apparatus of the present invention can be applied when analyzing the power consumption in various machines and equipment such as industrial robots, service robots, and processing machines operated by numerical control by computers in addition to production equipment. For example, the present invention can be applied when obtaining, classifying, and displaying power consumption data for a machine or equipment capable of automatically performing extension/contraction, bending, vertical movement, horizontal movement, turning, or a composite motion of these on the basis of information in a storage device provided in a control apparatus.

An operation which an apparatus is caused to perform when applying the information processing method or information processing apparatus of the present invention and analyzing the power consumption is typically an operation related to production of a product representative examples of which include assembly, conveyance, processing, cleaning, and the like of parts. Examples of the processing include cutting, polishing, hole boring, painting, bonding, and welding. However, the information processing such as acquisition, analysis, and display of the power consumption according to the present embodiment may be applied when causing the apparatus to execute an operation different from these.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-018995, filed Feb. 10, 2023, and Japanese Patent Application No. 2024-001678, filed Jan. 10, 2024, which are hereby incorporated by reference herein in their entirety.

What is claimed is:

1. An information processing apparatus comprising:
a classification information obtaining portion configured to obtain classification group information including a plurality of classification groups in each of which a classification item is configured, and association information associating the classification items of the plurality of classification groups with each other;
a data obtaining portion configured to obtain data of power consumed in a facility; and
a classification processing portion configured to classify the data obtained by the data obtaining portion, by using the classification group information and the association information obtained by the classification information obtaining portion.

2. The information processing apparatus according to claim 1, wherein the classification group information includes a classification group into which a power system of the facility is hierarchically classified.

3. The information processing apparatus according to claim 2, wherein the classification group into which the power system of the facility is hierarchically classified includes at least one of a substation, a switchboard, and a distribution board as a classification item.

4. The information processing apparatus according to claim 1, wherein the classification group information includes a classification group into which an operation system of the facility is hierarchically classified.

5. The information processing apparatus according to claim 4, wherein the classification group into which the operation system of the facility is hierarchically classified includes at least one of a building, a workplace, equipment, and a unit constituting the equipment as a classification item.

6. The information processing apparatus according to claim 1, wherein the classification group information includes a classification group into which uses of energy consumed in the facility are hierarchically classified.

7. The information processing apparatus according to claim 6, wherein the classification group into which uses of energy consumed in the facility are hierarchically classified includes at least one of a thermal use, a driving use, an air use, and a vacuum use as a classification item.

8. The information processing apparatus according to claim 1, wherein the classification group information includes a classification group into which added values generated in the facility are hierarchically classified.

9. The information processing apparatus according to claim 8, wherein the classification group into which the added values generated in the facility are hierarchically classified includes at least one of a net, an incident, and a waste as a classification item.

10. The information processing apparatus according to claim 8, the classification group into which the added values generated in the facility are hierarchically classified includes a classification item related to time and/or a classification item related to energy.

11. The information processing apparatus according to claim 1, wherein the classification processing portion classifies the data obtained by the data obtaining portion, by using a classification group into which a power system of the facility is hierarchically classified and a classification group into which an operation system of the facility is hierarchically classified that are included in the classification group information.

12. The information processing apparatus according to claim 1, wherein the classification processing portion classifies the data obtained by the data obtaining portion, by using a classification group into which an operation system of the facility is hierarchically classified and a classification group into which added values generated in the facility are hierarchically classified that are included in the classification group information.

13. The information processing apparatus according to claim 1, wherein information about a classification result of the classification processing portion is displayed on a display portion.

14. The information processing apparatus according to claim 1, wherein information about a classification result of the classification processing portion is displayed as a graph on a display portion.

15. The information processing apparatus according to claim 1, wherein whether or not an abnormality has occurred in power consumed in the facility is determined on a basis of a standard value related to an operation time in the facility.

16. The information processing apparatus according to claim 1, wherein the classification group information includes a classification group in which energy consumed in the facility is classified as a renewable energy.

17. The information processing apparatus according to claim 1, wherein the data is classified into an incident or a waste on a basis of a standard time corresponding to content of operation performed in the facility.

18. The information processing apparatus according to claim 1, wherein a group is set among pieces of equipment of the facility on a basis of content of operation performed by the equipment.

19. The information processing apparatus according to claim 1, wherein hierarchies of the data that are not uniformized when obtained are uniformized to a hierarchy of a distribution board.

20. The information processing apparatus according to claim 1, wherein an intensity is set for energy consumed in the facility.

21. An information processing method comprising:
obtaining, by a classification information obtaining portion, classification group information including a plurality of classification groups in each of which a classification item is configured, and association information associating the classification items of the plurality of classification groups with each other;
obtaining, by a data obtaining portion, data of power consumed in a facility; and
classifying, by a classification processing portion, the data obtained by the data obtaining portion, by using the classification group information and the association information obtained by the classification information obtaining portion.

22. A non-transitory computer-readable recording medium storing a program for causing a computer to execute the information processing method according to claim 21.
